(19) United States
(12) Patent Application Publication
(10) Pub. No.: US 2016/0350486 A1
(43) Pub. Date: Dec. 1, 2016

(54) NATURAL LANGUAGE PROCESSING FOR MEDICAL RECORDS

(71) Applicant: 3M INNOVATIVE PROPERTIES COMPANY, Saint Paul, MN (US)

(72) Inventors: Cathy L. PLUNKETT, Kennesaw, GA (US); Steven M AUSTIN, Spring Branch, TX (US); Garri L. GARRISON, Leitchfield, KY (US); Jason M. MARK, Fruit Heights, UT (US)

(21) Appl. No.: 15/116,831

(22) PCT Filed: Feb. 4, 2015
(86) PCT No.: PCT/US15/14366

§ 371 Date: Aug. 5, 2016

Related U.S. Application Data
(60) Provisional application No. 61/936,220, filed on Feb. 5, 2014.

(51) Int. Cl. G06F 19/00; G06F 17/27

(52) U.S. Cl. CPC G06F 19/322; G06F 17/2775; G06F 17/2705

(57) ABSTRACT

Techniques described herein provide methods for analyzing quality of care, site of service guidelines, patient condition lists, coordination of care, and patient discharge summaries. In one example of these techniques, with respect to patient condition lists, the disclosure is directed to a method for analyzing medical documentation. One or more computing devices store a plurality of medical records for a single patient. The one or more computing devices analyze information contained in the plurality of medical records. The one or more computing devices identify a list of chronic conditions for the patient and a list of one-time medical conditions for the patient based on a number of instances the patient has sought medical attention for the given conditions. The one or more computing devices output the list of chronic conditions for the patient and the list of one-time medical conditions for the patient.

### TECHNICAL FIELD

The invention relates to medical record systems.

### BACKGROUND

Within healthcare, there are many examples of regulatory, quality, compliance and reporting requirements that impose a burden on doctors, nurses, documentation improvement specialists, coders (nosologist), care managers, quality officers, and other healthcare personas. Each of these scenarios typically follow a pattern of requiring a set of discrete data elements to be evaluated against some set of normative criteria for purposes of determining if a particular decision affecting the care of a patient is correct in accordance with pre-established guidelines, or creation/coordination of information into and between the electronic health record (EHR). Further, auditing billing procedures, especially when the government is being charged, are inefficient and rarely done. For example, Medicare was overcharged by $2.4 billion in 2012 alone. When a hospital overcharges Medicare, if the government discovers the error before the hospital reports it, the hospital must pay the government the overcharged amount plus a penalty, making this auditing process important to the sustainability of a hospital.

The collection of the appropriate factors for various scenarios, including quality process measurement, following site of service guidelines, compiling problem lists, coordinating care, creating a discharge summary, and auditing bills, is often times challenging, time consuming, and requires extra communication steps between various parties in the healthcare delivery system in order to complete. The time involved may on occasion affect the care delivered to a patient as some care decisions need to be made immediately and there generally is not adequate time to complete the necessary reviews for the various entities with interest in that particular patient's care.

The end result of these challenges is: 1) Significant time is spent gathering or creation of data for evaluation against the various criteria sets by multiple people within the healthcare delivery system, 2) Patient care may be affected by decisions that need to be made more quickly than the review cycle time, time to access, or time to research the data, and 3) Hospital facility and/or provider scoring against criteria sets may be adversely affected resulting in changes to reimbursement or other publicly reported measurements reflecting on the facility or providers.

### SUMMARY

In general, the disclosure is directed to various methods of handling electronic medical records. In each method, a plurality of medical records are stored. Textual or numeric information in the medical records is analyzed. In some cases, other data may be stored, such as coded administrative data, mandated regulatory reporting measures, and site of service criteria. In the various examples, these medical records and the possible accompanying data are compared, assembled, or sorted. The results of these comparisons, assemblies, and sorts are then outputted at an output device.

In one embodiment, the disclosure is directed to a method for analyzing medical documentation. One or more computing devices store a plurality of medical records and coded administrative data. The one or more computing devices compare information contained in the plurality of medical records with information contained in coded administrative data. The one or more computing devices identify one or more risks based on the comparison of the information contained in the plurality of medical records with the information contained in the coded administrative data. The one or more computing devices output information associated with the one or more risks in the medical documentation.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records and coded administrative data. The natural language processing module compares information contained in the plurality of medical records with information contained in the coded administrative data. The natural language processing module identifies one or more risks based on the comparison of the information contained in the plurality of medical records with the information contained in the coded administrative data. The natural language processing module outputs information associated with the one or more risks in the medical documentation.

In another embodiment, the disclosure is directed to a computer-readable medium containing instructions. The instructions cause a processor to analyze medical documentation, wherein upon execution the instructions cause the processor to store a plurality of medical records and coded administrative data. The instructions also cause the processor to compare information contained in the plurality of medical records with information contained in the coded administrative data. The instructions also cause the processor to identify one or more risks based on the comparison of the information contained in the plurality of medical records with the information contained in the coded administrative data. The instructions also cause the processor to output information associated with the one or more risks in the medical documentation.

In one embodiment, the disclosure is directed to a method for analyzing medical documentation. One or more computing devices store a plurality of medical records and mandated regulatory reporting measures. The one or more computing devices compare information contained in the plurality of medical records with information contained in mandated regulatory reporting measures for a given procedure or diagnosis. The one or more computing devices identify a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis. The one or more computing devices output the pass/fail indication.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records and mandated regulatory reporting measures. The natural language processing module compares information contained in the plurality of medical records with information contained in the mandated regulatory reporting measures for a given procedure or diagnosis. The natural language processing module identifies a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis. The natural language processing module outputs the pass/fail indication.

In another embodiment, the disclosure is directed to a computer-readable medium containing instructions. The instructions cause a processor to analyze medical documentation, wherein upon execution the instructions cause the processor to store a plurality of medical records and mandated regulatory reporting measures. The instructions also cause the processor to compare information contained in the plurality of medical records with information contained in the mandated regulatory reporting measures for a given procedure or diagnosis. The instructions also cause the processor to identify a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis. The instructions also cause the processor to output the pass/fail indication.

In one embodiment, the disclosure is directed to a method for analyzing medical documentation. One or more computing devices store a plurality of medical records and site of service criteria. The one or more computing devices compare information contained in the plurality of medical records with a portion of information contained in the site of service criteria required for a site of service status in the plurality of medical records. The one or more computing devices identify a pass/fail indication based on the comparison of the information contained in the plurality of medical records with the portion of information contained in the site of service criteria based on whether the information contained in the plurality of medical records includes the portion of information contained in the set of site of service criteria. The one or more computing devices output the pass/fail indication.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records and site of service criteria. The natural language processing module compares information contained in the plurality of medical records with a portion of information contained in the site of service criteria required for a site of service status in the plurality of medical records. The natural language processing module identifies a pass/fail indication based on the comparison of the information contained in the plurality of medical records with the portion of information contained in the site of service criteria based on whether the information contained in the plurality of medical records includes the portion of information contained in the set of site of service criteria. The natural language processing module outputs the pass/fail indication.

In another embodiment, the disclosure is directed to a computer-readable medium containing instructions. The instructions cause a processor to analyze medical documentation, wherein upon execution the instructions cause the processor to store a plurality of medical records and site of service criteria. The instructions also cause the processor to compare information contained in the plurality of medical records a portion of information contained in the site of service criteria required for a site of service status in the plurality of medical records. The instructions also cause the processor to identify a pass/fail indication based on the comparison of the information contained in the plurality of medical records with the portion of information contained in the site of service criteria based on whether the information contained in the plurality of medical records includes the portion of information contained in the set of site of service criteria. The instructions also cause the processor to output the pass/fail indication.

In one embodiment, the disclosure is directed to a method for analyzing medical documentation. One or more computing devices store a plurality of medical records for a single patient. The one or more computing devices analyze information contained in the plurality of medical records. The one or more computing devices identify a list of chronic conditions for the patient and a list of one-time medical conditions for the patient based on a number of instances the patient has sought medical attention for the given conditions. The one or more computing devices output the list of chronic conditions for the patient and the list of one-time medical conditions for the patient.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records for a single patient. The natural language processing module analyzes information contained in the plurality of medical records. The natural language processing module identifies a list of chronic conditions for the patient and a list of one-time medical conditions for the patient based on a number of instances the patient has sought medical attention for the given conditions. The natural language processing module outputs the list of chronic conditions for the patient and the list of one-time medical conditions for the patient.

In another embodiment, the disclosure is directed to a computer-readable medium containing instructions. The instructions cause a processor to analyze medical documentation, wherein upon execution the instructions cause the processor to store a plurality of medical records for a single patient. The instructions also cause the processor to analyze information contained in the plurality of medical records. The instructions also cause the processor to identify a list of chronic conditions for the patient and a list of one-time medical conditions for the patient based on a number of instances the patient has sought medical attention for the given conditions. The instructions also cause the processor to output the list of chronic conditions for the patient and the list of one-time medical conditions for the patient.

In one embodiment, the disclosure is directed to a method for analyzing medical documentation. One or more computing devices store a plurality of medical records and coded administrative data. The one or more computing devices analyze information contained in the plurality of medical records and information contained in coded administrative data. The one or more computing devices assemble a condensed patient summary based on the information contained in the plurality of medical records and the information contained in the coded administrative data. The one or more computing devices output the condensed patient summary.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records and coded administrative data. The natural language processing module analyzes information contained in the plurality of medical records and information contained in coded administrative data. The natural language processing module assembles a condensed patient summary based on the information contained in the plurality of medical records and the information contained in the coded administrative data. The natural language processing module outputs the condensed patient summary.

In another embodiment, the disclosure is directed to a computer-readable medium containing instructions. The instructions cause a processor to analyze medical documentation, wherein upon execution the instructions cause the processor to store a plurality of medical records and coded administrative data. The instructions also cause the processor to analyze information contained in the plurality of medical records and information contained in coded administrative data. The instructions also cause the processor to assemble a condensed patient summary based on the information contained in the plurality of medical records and the information contained in the coded administrative data. The instructions also cause the processor to output the condensed patient summary.

In one embodiment, the disclosure is directed to a method for analyzing medical documentation. One or more computing devices store a plurality of medical records and coded administrative data. The one or more computing devices analyze information contained in the plurality of medical records and information contained in the coded administrative data. The one or more computing devices sort the information contained in the plurality of medical records and the information contained in the coded administrative data into a plurality of discharge summary components. The one or more computing devices output the discharge summary.

In another embodiment, the disclosure is directed to a computerized system for analyzing medical documentation, the system comprising one or more computing devices that each includes a processor and a memory, wherein the processor is configured to include a natural language processing module. The natural language processing module stores a plurality of medical records and coded administrative data. The natural language processing module analyzes information contained in the plurality of medical records and information contained in the coded administrative data. The natural language processing module sorts the information contained in the plurality of medical records and the information contained in the coded administrative data into a plurality of discharge summary components. The natural language processing module outputs the discharge summary.

In another embodiment, the disclosure is directed to a computer-readable medium containing instructions. The instructions cause a processor to analyze medical documentation, wherein upon execution the instructions cause the processor to store a plurality of medical records and coded administrative data. The instructions also cause the processor to analyze information contained in the plurality of medical records and information contained in the coded administrative data. The instructions also cause the processor to sort the information contained in the plurality of medical records and the information contained in the coded administrative data into a plurality of discharge summary components. The instructions also cause the processor to output the discharge summary.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example of a standalone computing device for auditing medical records, in accordance with one or more techniques of the current disclosure.

FIG. 2 is a block diagram illustrating an example of a distributed system for auditing medical records, in accordance with one or more techniques of the current disclosure.

FIG. 3 is a screenshot of a system that implements the process for auditing medical records, in accordance with one or more techniques of the current disclosure.

FIG. 4 is a flow diagram illustrating a method for auditing medical records, in accordance with one or more techniques of the current disclosure.

FIG. 5 is a block diagram illustrating the communication between different billing data stores in the process of auditing medical records, in accordance with one or more techniques of the current disclosure.

FIGS. 6-14 are screenshots of a system that implements the process for auditing medical records, in accordance with one or more techniques of the current disclosure.

FIG. 15 is a block diagram of an analytics platform that implements methods of the current disclosure, in accordance with one or more techniques of the current disclosure.

FIG. 16 is an abstraction of regulatory reporting, in accordance with one or more techniques of the current disclosure.

FIG. 17 is a block diagram illustrating an example of a standalone computing device for quality control, in accordance with one or more techniques of the current disclosure.

FIG. 18 is a block diagram illustrating an example of a distributed system for quality control, in accordance with one or more techniques of the current disclosure.

FIG. 19 is a block diagram illustrating an example of a standalone computing device for assessing site of service qualifications, in accordance with one or more techniques of the current disclosure.

FIG. 20 is a block diagram illustrating an example of a distributed system for assessing site of service qualifications, in accordance with one or more techniques of the current disclosure.

FIG. 21 is a block diagram illustrating an example of a standalone computing device for identifying chronic patient conditions, in accordance with one or more techniques of the current disclosure.

FIG. 22 is a block diagram illustrating an example of a distributed system for identifying chronic patient conditions, in accordance with one or more techniques of the current disclosure.

FIG. 23 is a block diagram illustrating an example of a standalone computing device for coordination of care, in accordance with one or more techniques of the current disclosure.

FIG. 24 is a block diagram illustrating an example of a distributed system for coordination of care, in accordance with one or more techniques of the current disclosure.

FIG. 25 is a block diagram illustrating an example of a standalone computing device for creating a discharge summary, in accordance with one or more techniques of the current disclosure.

FIG. 26 is a block diagram illustrating an example of a distributed system for creating a discharge summary, in accordance with one or more techniques of the current disclosure.

FIG. 27 is a flow diagram illustrating a method for auditing medical records, in accordance with one or more techniques of the current disclosure.

FIG. 28 is a flow diagram illustrating a method for quality control, in accordance with one or more techniques of the current disclosure.

FIG. 29 is a flow diagram illustrating a method for assessing site of service qualifications, in accordance with one or more techniques of the current disclosure.

FIG. 30 is a flow diagram illustrating a method for identifying chronic patient conditions, in accordance with one or more techniques of the current disclosure.

FIG. 31 is a flow diagram illustrating a method for coordination of care, in accordance with one or more techniques of the current disclosure.

FIG. 32 is a flow diagram illustrating a method for creating a discharge summary, in accordance with one or more techniques of the current disclosure.

### DETAILED DESCRIPTION

The current disclosure leverages Natural Language Processing (NLP) to reduce or eliminate the burden placed on healthcare providers by regulatory and reporting processes by automating the extraction of appropriate data elements to meet those needs. NLP can identify various items in an electronic medical record, such as procedures, diagnoses, tests, test results, site of service, medications, or any other information that could be contained in an electronic medical record. It will further improve the delivery, quality, management, and compliance of care with established guidelines by shortening the time between the acquisition of relevant information and the notification to providers of interventions or clarifications required to fully document and establish appropriateness of care provided. The compliance application overcomes the challenges associated with other computer assisted coding applications in its ability to look across multiple documents using an enterprise patient record store that will associate multiple documents as well as multiple encounter data outputs to a single patient. Current applications are limited to single event (document, encounter data) analysis.

In one example, the current disclosure describes an application and system that provides a unique workflow for identifying, reviewing, and investigating potential healthcare non-compliant billing and coding processes. Potential compliance risks can be proactively mitigated on an enterprise level to minimize potential for post-audit recoupment through the creation of action plans and tracking resolution. This is a data analytics solution for integrating data across providers, patients, and uses grouping logic to analyze, model, predict and take action on measures that are related to quality of care, cost avoidance, regulatory risks, and patient population management. It is part of a data analytics platform that uses data analysis combined with various health data dictionaries, preventive suite, and NLP.

Multiple factors affect the complexity of meeting these various reporting and regulatory scenarios. First of all it is common for the required data to be spread across multiple documentation media, formats, and systems. For example a portion of the patient's healthcare record may be captured during a hospital's admissions process. The information captured may be paper based or manually captured in an electronic system. That information may or may not be connected to other systems in the hospital. The patient is then seen by a care provider who may record their interaction via a voice dictated report that is later transcribed by a medical transcriptionist, or may be entered directly into an electronic health record (EHR) as discrete data elements, as free form text, or as a combination of the two often requiring manual labor by the physician such as entering the patient problems and opening multiple EHRs to find the information. The individual then responsible for evaluating whether or not a patient's conditions or care meet certain criteria must review the medical record across these different formats to manually extract the fields needed for their evaluation. This problem may be simplified in some cases by adding new discrete data elements for capture within the electronic health record although this also becomes a challenge as new data elements are periodically required for various reporting and regulatory standards and the addition of those new fields may impose significant information technology (IT) burdens for the facility, pose training and adoption challenges for users of the system, or may not even be possible if a particular EHR does not allow for sufficient customization. Other challenges include if the physician does not enter data in discrete fields of the EHR, thus not being captured by any tools using EHR output. NLP allows capture of discrete and non-discrete data.

The current disclosure may provide some or all of the following benefits to healthcare facilities, providers, and organizations. Improvements to patient care may be possible through earlier feedback to providers regarding alignment of their actions with that of established care guidelines. Physicians may have an increased opportunity to improve scores on evaluation criteria (e.g. quality of care measures, etc.) by providing information necessary for earlier intervention to direct care according to said guidelines. Physician workflow and access to information can be improved by reducing manual labor by the physician through automation of problem lists, coordination of care documents and auto-created discharge summary drafts. Hospitals may have an increased opportunity to reduce personnel associated with the manual capture of data and the ability to capture non discrete data versus the EHR output as the solution. Hospitals may also have an increased opportunity to ensure the care delivered will be reimbursed appropriately by insurance, government, or other organizations by delivering information regarding which care choices will be reimbursed in time to affect said decisions.

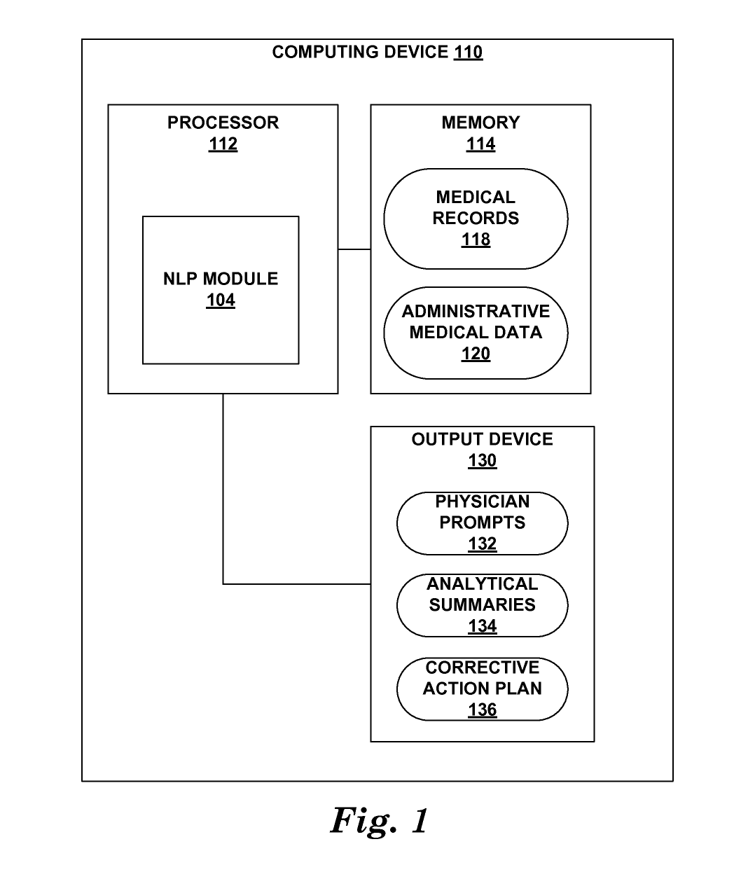

FIG. 1 is a block diagram illustrating an example of a standalone computing device for auditing medical records, in accordance with one or more techniques of the current disclosure. The system comprises computing device 110 that includes a processor 112, a memory 114, and an output device 130. Computing device 110 may also include many other components. The illustrated components are shown merely to explain various aspects of this disclosure. Computing device 110 may be a desktop computer, a tablet computer, a personal digital assistant (PDA), a laptop computer, a portable media player, an e-book reader, a watch, a television platform, or another type of computing device.

The output device 130 may comprise a display screen, although this disclosure is not necessarily limited in this respect, and other types of output devices may also be used. Memory 114 stores medical records 118, comprising textual and numeric information for a plurality of medical records, and administrative medical data 120, comprising coded medical procedures and charge data for said medical procedures. Processor 112 is configured to include an NLP module 104 which executes techniques of this disclosure with respect to medical records 118 and administrative medical data 120.

Processor 112 may comprise a general-purpose microprocessor, a specially designed processor, an application specific integrated circuit, a field programmable gate array, a collection of discrete logic, or any type of processing device capable of executing the techniques described herein. In one example, memory 114 may store program instructions (e.g., software instructions) that are executed by processor 112 to carry out the techniques described herein. In other examples, the techniques may be executed by specifically programmed circuitry of processor 112. In these or other ways, processor 112 may be configured to execute the techniques described herein.

Output device 130 may comprise a display screen, and may also include other types of output capabilities. In some cases, output device 130 may generally represent both a display screen and a printer in some cases. NLP module 104 may be configured to cause output device 130 to output physician prompts 132, analytical summaries 134, and corrective action plan 136. Physician prompts 132 may be generated, e.g., as output on a display screen, so as to allow a physician or other medical professional to add or modify portions of analytical summaries 134 and corrective action plan 136. Analytical summaries 134 may be generated, e.g., as output on a display screen, to indicate discrepancies between medical records 118 and administrative medical data 120. These discrepancies may be an indication that an overcharge has occurred in the billing process. Analytical summaries 134 may be empty in the case that there are no discrepancies found in the comparison of medical records 118 and administrative medical data 120. Analytical summaries 134 may show the discrepancies by displaying erroneous medical records from medical records 118 and/or erroneous billing codes from administrative medical data 120 with the incorrect portions highlighted or displayed in a color different from the remainder of the text. Corrective action plan 136 may be generated, e.g., as output on a display screen, so as to suggest a plan to a physician or other medical professional to correct any discrepancies listed in analytical summaries 134. If there are no discrepancies in analytical summaries 134, then corrective action plan 136 may also be empty. Otherwise, corrective action plan 136 may suggest alternate billing codes for the information contained in medical records 118. Corrective action plan 136 may be populated with information obtained from past corrective action plans that have been successfully applied to medical records with discrepancies similar to the case in question.

In one example, memory 114 stores medical records 118 and administrative medical data 120. These could be stored in databases, data warehouses, in cloud data structures, or on a hard disk, among other things. Medical records 118 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 120 could contain codes pertaining to charge data and costs that will be billed to a payer, such as the government or an insurance company, although the techniques of this disclosure may apply to other payers.

NLP module 104 is configured to associate different codes in administrative medical data 120 to specific natural language meanings. NLP module 104 translates the information contained in administrative medical data 120 into those natural language meanings to describe what a patient was charged for during their encounter in the medical facility. NLP module 104 then compares that information to medical records 118, which should also give a natural language description of what a patient was administered during their encounter in the medical facility.

NLP module 104 compares the information contained in medical records 118 and the information contained in administrative medical data 120. NLP module 104 may, in some examples, analyze the information contained in medical records 118 and the information contained in administrative medical data 120 by strictly comparing the two. In other examples, NLP module 104 may use a natural language processing model to parse out particular keywords and synonyms for those keywords in the information contained in medical records 118 and the information contained in administrative medical data 120. NLP module 104 may then compare those keywords and synonyms to reduce the number of false negatives incurred by the system by accounting for different terminologies used between different physicians and medical professionals or between a medical professional and the codes of administrative medical data 120.

NLP module 104 identifies one or more risks based on the comparison of the information contained in medical records 118 with information contained in coded administrative data 120. If NLP module 104 determines that the difference between the information contained in medical records 118 and the information contained in administrative medical data 120 may have led to a discrepancy in the billing process and an incorrect billing amount, NLP module 104 may identify that portion of medical records 118 and administrative medical data 120 as a risk.

NLP module 104 outputs information associated with the risks identified above in the form of physician prompts 132, analytical summaries 134, and corrective action plan 136. In some examples, corrective action plan 136 may be stored if it successfully addresses the discrepancy identified by NLP module 104 at memory 114. This successful corrective action plan may be shared across multiple patient records, allowing the corrective action plan to be referenced in case the same discrepancy shows up in a future implementation of the techniques described above. These successful corrective action plans can also be further modified by NLP module 104 if a better corrective action plan is discovered, dynamically improving compliance performance and resolution.

NLP module 104 may also flag particular codes in administrative medical data 120 when a discrepancy is found. If NLP module 104 determines that a discrepancy occurs with a particular code in administrative medical data 120, NLP module 104 may flag that code in administrative medical data 120 for future reference. If NLP module 104 reads a code that was previously flagged for a discrepancy, NLP module 104 may automatically highlight that portion of administrative medical data 120 in the analytical summaries to force the medical professionals assessing the risks to check that the code was used correctly in this instance.

In some examples, administrative medical data 120 may contain a single code set. In other examples, administrative medical data 120 may contain multiple code sets, and NLP module 104 may compare data among the multiple code sets. These code sets may be drawn from revisions of the International Statistical Classifications of Diseases and Related Health Problems (ICD), such as ICD-9 codes or ICD-10 codes, Snomed®, or the Current Procedural Terminology® (CPT®) codes, although the techniques are not necessarily limited to ICD medical codes, Snomed®, or CPT® codes and could apply with respect to other types of medical codes as would be apparent to one of skill in the art. These codes sets, in general, are any set of medical codes defined by a governmental organization, an industry, a company, or any other entity that would be relied upon in the medical field. In particular, other medical codes may be used with the techniques of this disclosure, particularly for billing to insurance companies or other non-governmental organizations, which may define their own code system or may adopt that of the ICD.

In one example, the current disclosure relates to a method for analyzing medical documentation. In this method one or more computing devices stores a plurality of medical records and coded administrative data. The one or more computing devices compares the information contained in the medical records with the information contained in coded administrative data. The one or more computing devices identifies one or more risks based on the comparison of the information contained in the medical records with information contained in the coded administrative data. The one or more computing devices outputs information associated with the one or more risks in the medical documentation.

The system of FIG. 1 is a standalone system in which processor 112 that executed NLP module 104 and output device 130 that outputs physician prompts 132, analytical summaries 134, and corrective action plan 136 reside on the same computing device 110. However, the techniques of this disclosure may also be performed in a distributed system that includes a server computing device and a client computing device. In this case, the client computing device may communicate with the server computing device via a network. The NLP module may reside on the server computing device, but the output device may reside on the client computing device. In this case, when the NLP module causes display prompts, the NLP module causes the output device of the client computing device to display the prompts, e.g., via commands or instructions communicated from the server computing device to the client computing device. The NLP module may simply avoid such commands or instructions if display of the prompts at the output device is avoided.

As part of the current disclosure, detailed corrective action plans can be created and results can be measured over time. As part of the Officer of Inspector General's (OIG) voluntary self-disclosure program that allows provider's to discover compliance risks, self-report, and make financial restitution without penalty, a corrective action plan is required to detail the steps taken by the provider to assure that the root cause for the error has been corrected and the provider has taken steps necessary to prevent future occurrences. This disclosure will allow participating customers to anonymously share “best practices” utilized to correct defects so that other customers can utilize/modify the plans to improve the compliance performance of the institution.

Professional and outpatient content are constructed to complete longitudinal compliance offering and consistency with the OIG workplan. Predictive aspects may be leveraged by importing or modifying [other institutional] successful workplans to improve the compliance performance of an institution.

The system also provides a point of coding solution that uses a combination of billing data, coded data, NLP, compliance focused alerts, and workflow to target risk areas and correct the coding and/or billing prior to submission of the claim. Where customers are deploying the application in a near real-time environment, user preferences can be utilized to establish priority levels of focus. The customer can use the base line reported data that will automatically surface the highest areas of historical risk to determine which key performance indicators will be surfaced to a reviewer. Using the features for NLP document processing and interfaces to administrative data, records flagged for review can be presented in work queues based on customer user preferences.

The application uses natural language processing to analyze text in the medical record documentation. In addition, the application uses administrative (coded billing) data. The highlighted phrases are compared to the administrative data to identify inconsistencies that identify a potential risk area. The application is combining the use of administrative (e.g., coded and charge) data with the natural language output to flag discrepancies.

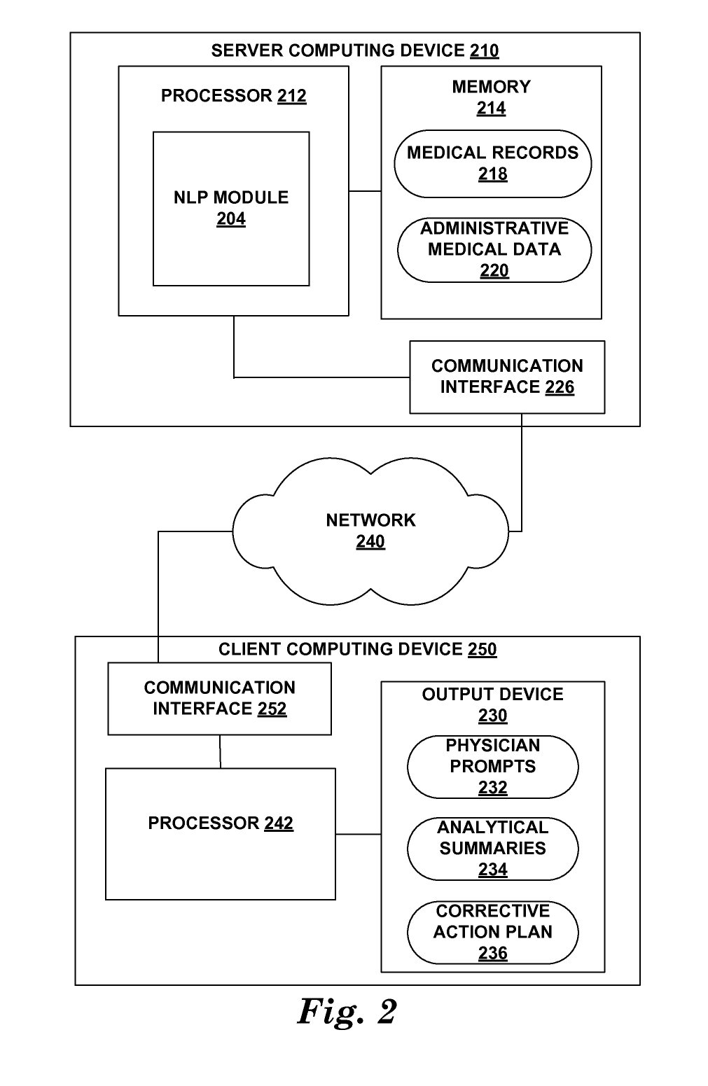

FIG. 2 is a block diagram illustrating an example of a distributed system for auditing medical records, in accordance with one or more techniques of the current disclosure. This system includes a server computing device 210 and a client computing device 250 that communicate via a network 240. Server computing device 210 may be implemented in a Cloud based environment. In the example of FIG. 2, network 240 may comprise a proprietary on non-proprietary network for packet-based communication. In one example, network 240 comprises the Internet, in which case communication interfaces 226 and 252 may comprise interfaces for communicating data according to transmission control protocol/internet protocol (TCP/IP), user datagram protocol (UDP), or the like. More generally, however, network 240 may comprise any type of communication network, and may support wired communication, wireless communication, fiber optic communication, satellite communication, or any type of techniques for transferring data between a source (e.g., server computing device 210) and a destination (e.g., client computing device 240).

Server computing device 210 may perform the techniques of this disclosure, but a user may interact with the system via client computing device 250. Server computing device 210 may include a processor 212, a memory 214, and a communication interface 226. Client computing device 250 may include a communication interface 252, a processor 242 and an output device 230. Of course, client computing device 250 and server computing device 210 may include many other components. The illustrated components are shown merely to explain various aspects of this disclosure.

Output device 230 may comprise a display screen, although this disclosure is not necessarily limited in this respect and other output devices may also be used. Memory 214 stores medical records 218 comprising a plurality of medical records, as well as administrative medical data 220, comprising coded medical procedures and charge data for said medical procedures. Processor 212 of server computing device 210 is configured to include a NLP module 204 which executes techniques of this disclosure with respect to medical records 218 and administrative medical data 220.

Processors 212 and 242 may each comprise a general-purpose microprocessor, a specially designed processor, an application specific integrated circuit, a field programmable gate array, a collection of discrete logic, or any type of processing device capable of executing the techniques described herein. In one example, memory 214 may store program instructions (e.g., software instructions) that are executed by processor 212 to carry out the techniques described herein. In other examples, the techniques may be executed by specifically programmed circuitry of processor 212. In these or other ways, processor 212 may be configured to execute the techniques described herein.

Output device 230 on client computing device 250 may comprise a display screen, and may also include other types of output capabilities. In some cases, output device 230 may generally represent both a display screen and a printer in some cases. NLP module 204 may be configured to cause output device 230 of client computing device 250 to output physician prompts 232, analytical summaries 234, and corrective action plan 236. Physician prompts 232 may be generated, e.g., as output on a display screen, so as to allow a physician or other medical professional to add or modify portions of analytical summaries 234 and corrective action plan 236. Analytical summaries 234 may be generated, e.g., as output on a display screen, to indicate discrepancies between medical records 218 and administrative medical data 220. These discrepancies may be an indication that an overcharge has occurred in the billing process. Analytical summaries 234 may be empty in the case that there are no discrepancies found in the comparison of medical records 218 and administrative medical data 220. Analytical summaries 234 may show the discrepancies by displaying erroneous medical records from medical records 218 and/or erroneous billing codes from administrative medical data 220 with the incorrect portions highlighted or displayed in a color different from the remainder of the text. Corrective action plan 236 may be generated, e.g., as output on a display screen, so as to suggest a plan to a physician or other medical professional to correct any discrepancies listed in analytical summaries 234. If there are no discrepancies in analytical summaries 234, then corrective action plan 236 may also be empty. Otherwise, corrective action plan 236 may suggest alternate billing codes for the information contained in medical records 218. Corrective action plan 236 may be populated with information obtained from past corrective action plans that have been successfully applied to medical records with discrepancies similar to the case in question.

Similar to the standalone example of FIG. 1, in the distributed example of FIG. 2, in one example, memory 214 stores medical records 218 and administrative medical data 220. These could be stored in databases, data warehouses, in a cloud data structure, in a cloud data structure, or on a hard disk, among other things. Medical records 218 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 220 could contain codes pertaining to charge data and costs that will be billed to a payer, such as the government or an insurance company, although the techniques of this disclosure may apply to other payers.

NLP module 204 is configured to associate different codes in administrative medical data 220 to specific natural language meanings. NLP module 204 translates the information contained in administrative medical data 220 into those natural language meanings to describe what a patient was charged for during their encounter in the medical facility. NLP module 204 then compares that information to medical records 218, which should also give a natural language description of what a patient was administered during their encounter in the medical facility.

NLP module 204 compares the information contained in medical records 218 and the information contained in administrative medical data 220. NLP module 204 may, in some examples, analyze the information contained in medical records 218 and the information contained in administrative medical data 220 by strictly comparing the two. In other examples, NLP module 204 may use a natural language processing model to parse out particular keywords and synonyms for those keywords in the information contained in medical records 218 and the information contained in administrative medical data 220. NLP module 204 may then compare those keywords and synonyms to reduce the number of false negatives incurred by the system by accounting for different terminologies used between different physicians and medical professionals or between a medical professional and the codes of administrative medical data 220.

NLP module 204 identifies one or more risks based on the comparison of the information contained in medical records 218 with information contained in coded administrative data 220. If NLP module 204 determines that the difference between the information contained in medical records 218 and the information contained in administrative medical data 220 may have led to a discrepancy in the billing process and an incorrect billing amount, NLP module 204 may identify that portion of medical records 218 and administrative medical data 220 as a risk.

NLP module 204 outputs, at output device 230 of client computing device 250, information associated with the risks identified above in the form of physician prompts 232, analytical summaries 234, and corrective action plan 236. In some examples, corrective action plan 236 may be stored if it successfully addresses the discrepancy identified by NLP module 204 at memory 214 of server computing device 210. This successful corrective action plan may be shared across multiple patient records, allowing the corrective action plan to be referenced in case the same discrepancy shows up in a future implementation of the techniques described above. These successful corrective action plans can also be further modified by NLP module 204 if a better corrective action plan is discovered, dynamically improving compliance performance and resolution.

Communication interfaces 226 and 252 allow for communication between server computing device 210 and client computing device 250 via network 240. In this way, NLP module 204 may execute on server computing device 210 but the output may appear on output device 230 of client computing device 250. A user operating on client computing device 250 may log-on or otherwise access NLP module 204 of server computing device 210, such as via a web-interface operating on the Internet or a propriety network, or via a direct or dial-up connection between client computing device 250 and server computing device 210. In some cases, data displayed on output device 230 may be arranged in web pages served from server computing device 210 to client computing device 250 via hypertext transfer protocol (HTTP), extended markup language (XML), or the like.

NLP module 204 may also flag particular codes in administrative medical data 220 when a discrepancy is found. If NLP module 204 determines that a discrepancy occurs with a particular code in administrative medical data 220, NLP module 204 may flag that code in administrative medical data 220 for future reference. If NLP module 204 reads a code that was previously flagged for a discrepancy, NLP module 204 may automatically highlight that portion of administrative medical data 220 in the analytical summaries to force the medical professionals assessing the risks to check that the code was used correctly in this instance.

In some examples, administrative medical data 220 may contain a single code set. In other examples, administrative medical data 220 may contain multiple code sets, and NLP module 204 may compare data among the multiple code sets. These code sets may be drawn from revisions of the International Statistical Classifications of Diseases and Related Health Problems (ICD), such as ICD-9 codes or ICD-10 codes, Snomed®, or the Current Procedural Terminology® (CPT®) codes, although the techniques are not necessarily limited to ICD, Snomed®, or CPT® medical codes and could apply with respect to other types of medical codes as would be apparent to one of skill in the art. In particular, other medical codes may be used with the techniques of this disclosure, particularly for billing to insurance companies or other non-governmental organizations, which may define their own code system or may adopt that of the ICD.

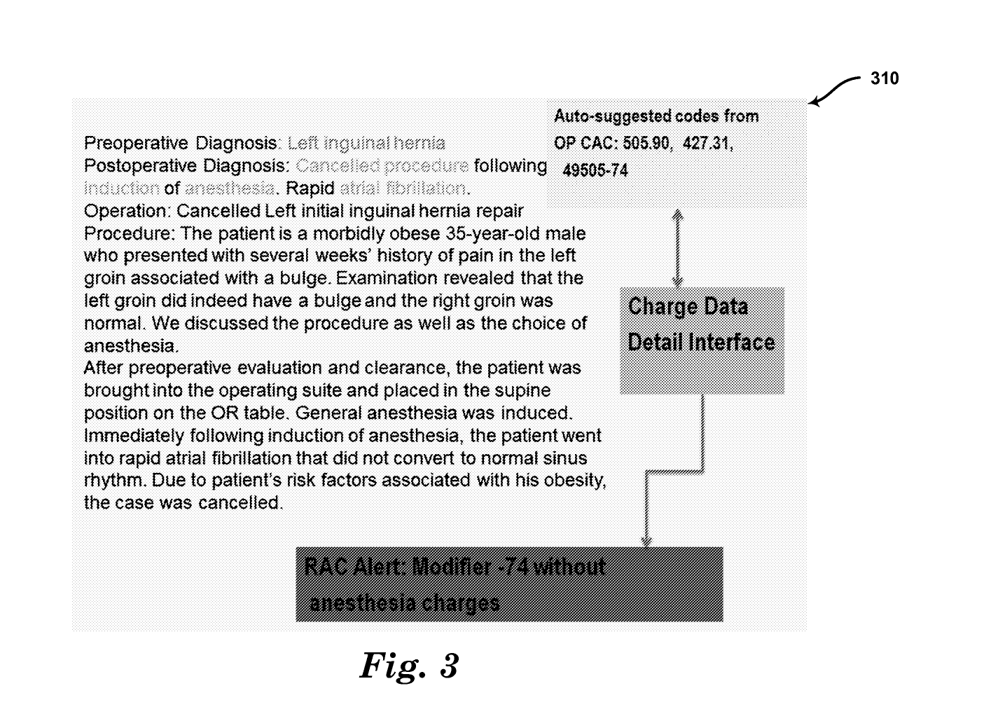

FIG. 3 is a screenshot of a system that implements the process for auditing medical records, in accordance with one or more techniques of the current disclosure. This screen shot may be delivered to output device 130 of computing device 110 shown in FIG. 1 or output device 230 of client computer 250 shown in FIG. 2. The screen shot may be generated as part of a processing routine (e.g., NLP module 104 or 204) executed by processor 112 of computer 110 shown in FIG. 1, or executed by processor 212 of client computer 250 shown in FIG. 2.

Screenshot 310 shows a medical record output, in accordance with one or more techniques of the current disclosure. Screenshot 310 shows portions of text that are highlighted to show where discrepancies in the medical record (e.g., medical records 118) exist. Screenshot 310 also shows charge data to indicate the coded administrative data (e.g., coded administrative data 120) that was entered for the case in question. Screenshot 310 also shows an alert flag and suggested codes for a corrective action plan (e.g., corrective action plan 136). Physician compliance tools detect potential up-coding (in real-time) providing insight with respect to documentation issues, medical necessity, and other specialty related issues.

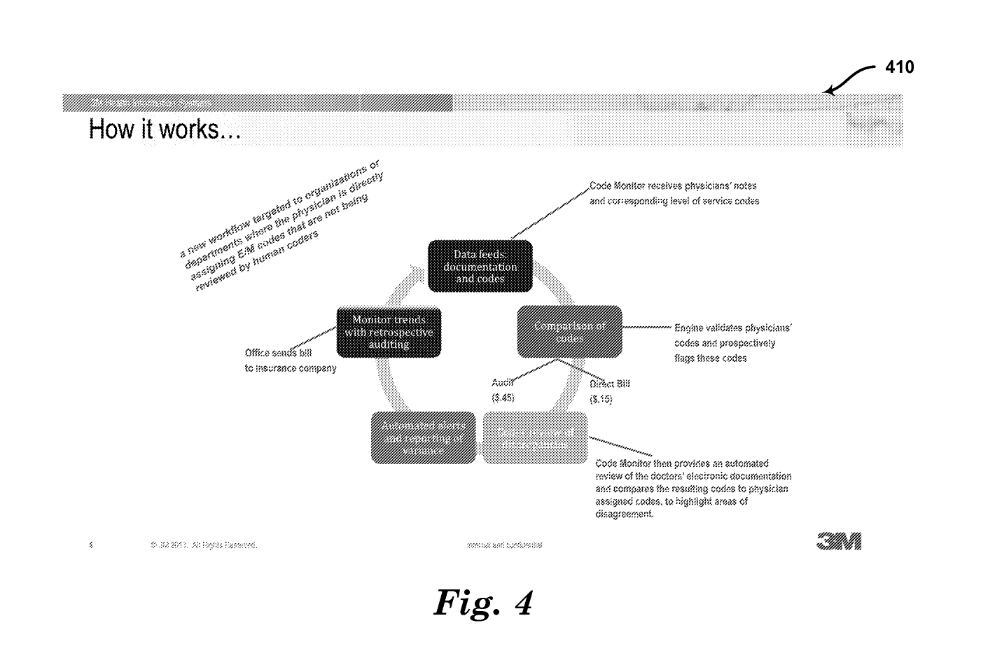

FIG. 4 is a flow diagram illustrating a method for auditing medical records, in accordance with one or more techniques of the current disclosure. In workflow 410, codes are not being reviewed by human coders. In workflow 410, medical records and coded administrative data are stored when a code monitor receives a physician's notes and the corresponding level of service codes. This information is then compared, with an engine validating the codes and prospectively flagging any codes that have caused errors in the past. Once the discrepancies are flagged and output, they can be reviewed by a user, where the areas of discrepancy may be highlighted. Automated alerts are generated for the areas of discrepancy, and any variance is reported. The system can also keep track of past discrepancies in order to monitor trends for future audits. The system also sends a correct bill to the payer.

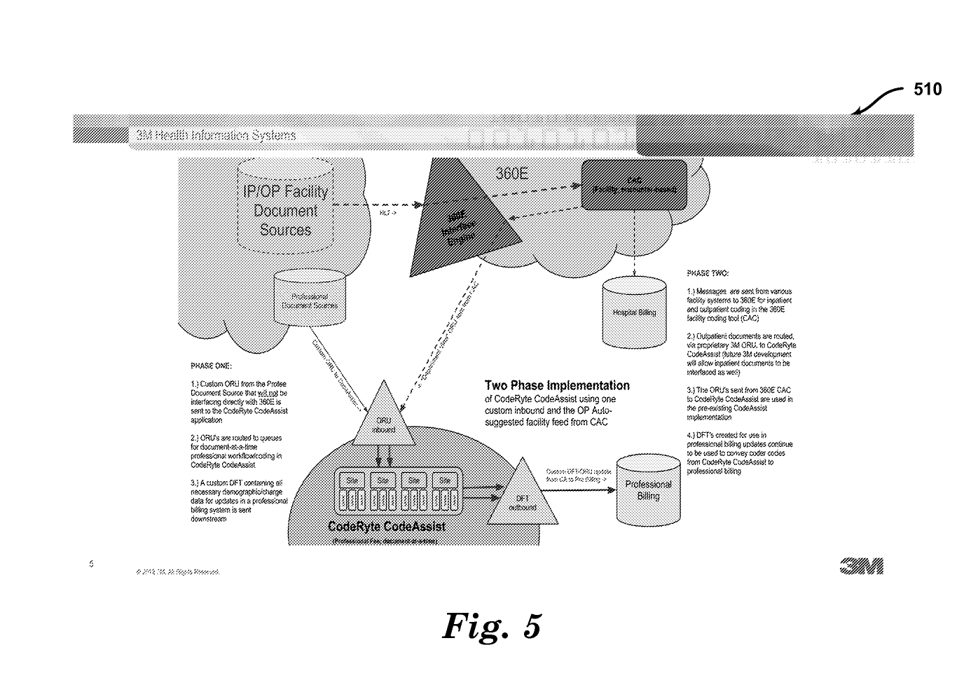

FIG. 5 is a block diagram illustrating the communication between different billing data stores in the process of auditing medical records, in accordance with one or more techniques of the current disclosure. In this layout 510, the application links outputs from various disparate systems together using interfaces. The systems involved are electronic health records, the hospital and physician/professional service provider billing systems, and the techniques in accordance with this disclosure.

In phase 1, documents are sent to a coder device and placed in a document-at-a-time queue. A custom codes containing the coded administrative data is then sent downstream from the coder device. In phase 2, messages from various facilities containing medical records and the coded administrative data are sent to a device implementing the techniques of the current disclosure. The results of any discrepancies are sent back to the coder device where they can be analyzed and sent out as professional billing.

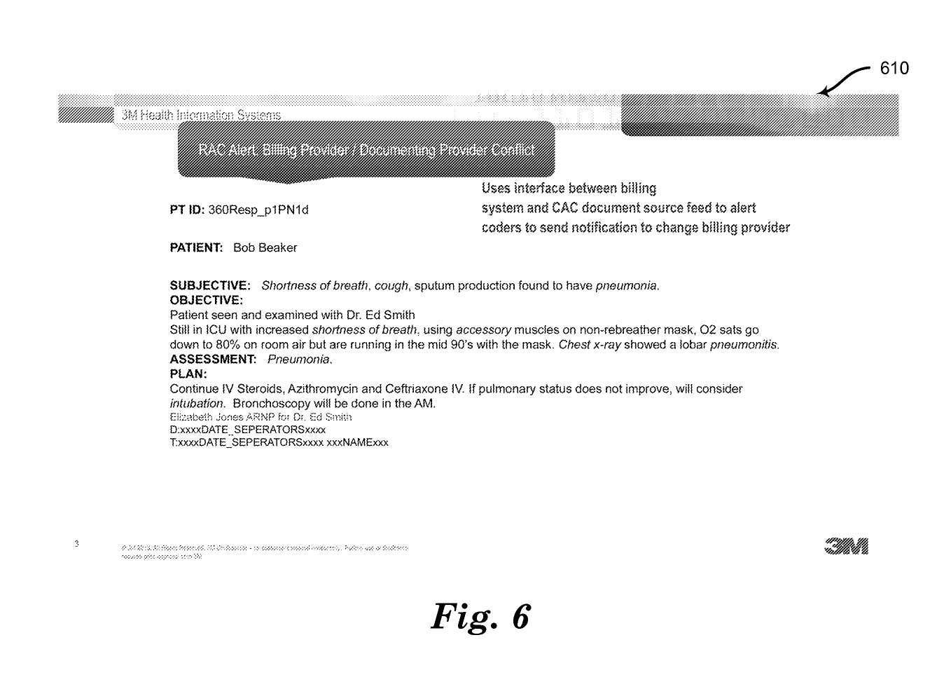

FIGS. 6-14 are screenshots of a system that implements the process for auditing medical records, in accordance with one or more techniques of the current disclosure. These screen shots may be delivered to output device 130 of computing device 110 shown in FIG. 1 or output device 230 of client computer 250 shown in FIG. 2. The screen shot may be generated as part of a processing routine (e.g., NLP module 104 or 204) executed by processor 112 of computer 110 shown in FIG. 1, or executed by processor 212 of client computer 250 shown in FIG. 2.

In the compliance application, the electronic documentation is compared to the administrative data (e.g., coded and charge detail including other data elements that represent billing provider and site of service) to identify and highlight using NLP areas of discrepancies. In screenshot 610 of FIG. 6, an alert is provided to the user based on an overcharge where the billing provider changed but was not recognized in the billing codes. This alert can be a general alarm or alert that an overcharge has happened, or it can be a specialized alert to warn the user of a specifically found overcharge. For instance, this alert could be a recovery audit contractor (RAC) alert.

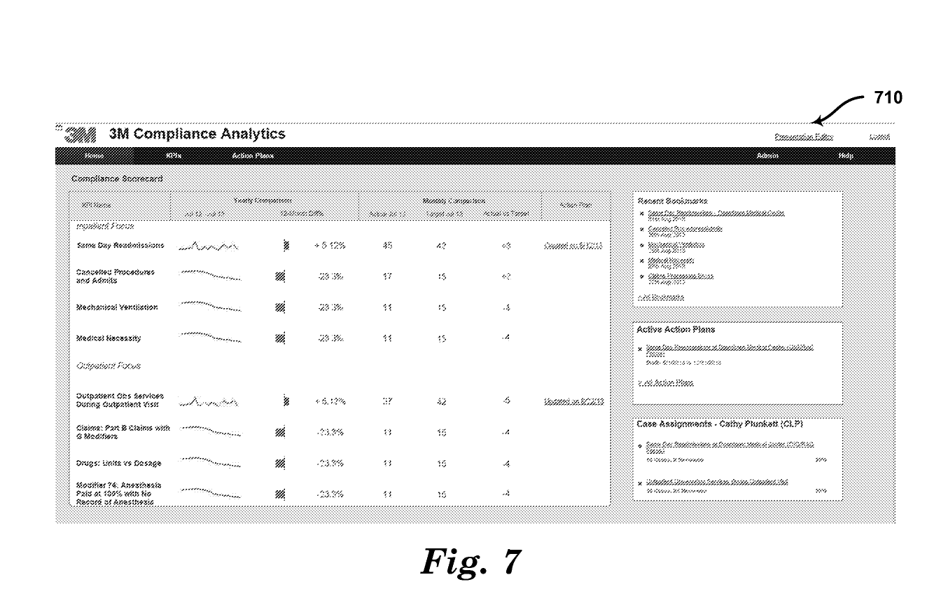

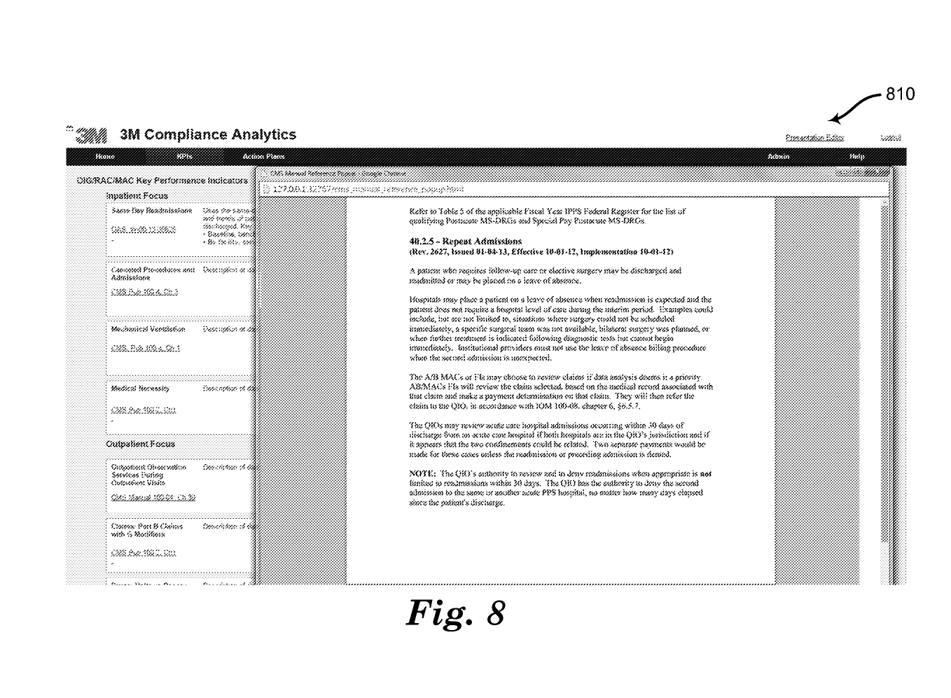

In FIG. 7, screenshot 710 shows a table of compliance analysis statistics in charts. Since the techniques of the current disclosure can flag particular codes for future attention and look across multiple medical records, data regarding different procedures and compliance statistics can be kept. In FIG. 8, screenshot 810 shows a similar compliance analysis, but with words and natural language instead of charts.

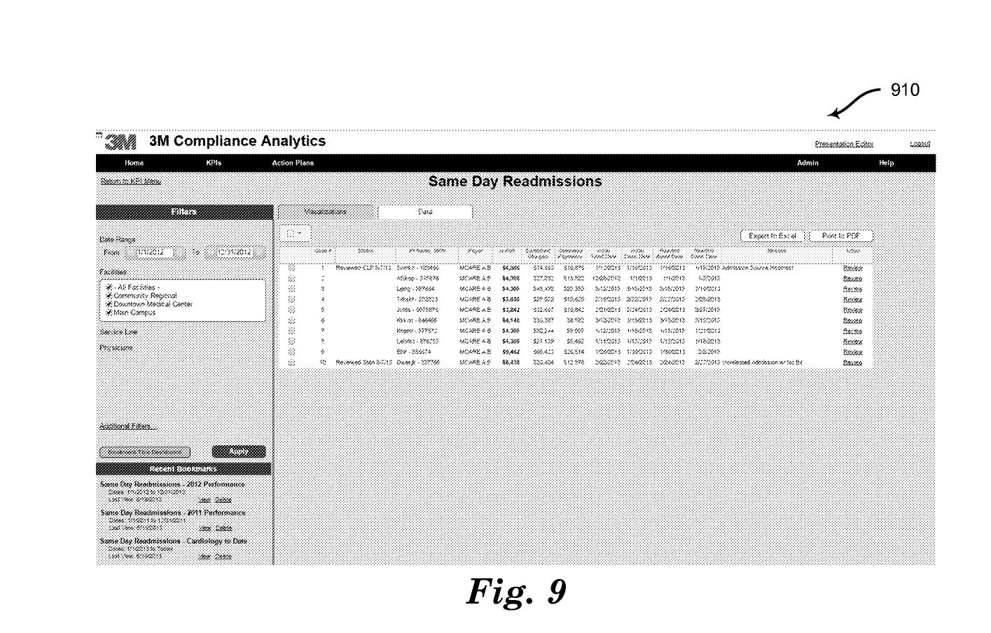

FIG. 9 shows a screenshot 910 of a detailed analysis regarding a single type of billing code. Here, the code in question deals with same day readmissions, with a listing of various times that code was flagged, along with the result of what happened when that code was flagged.

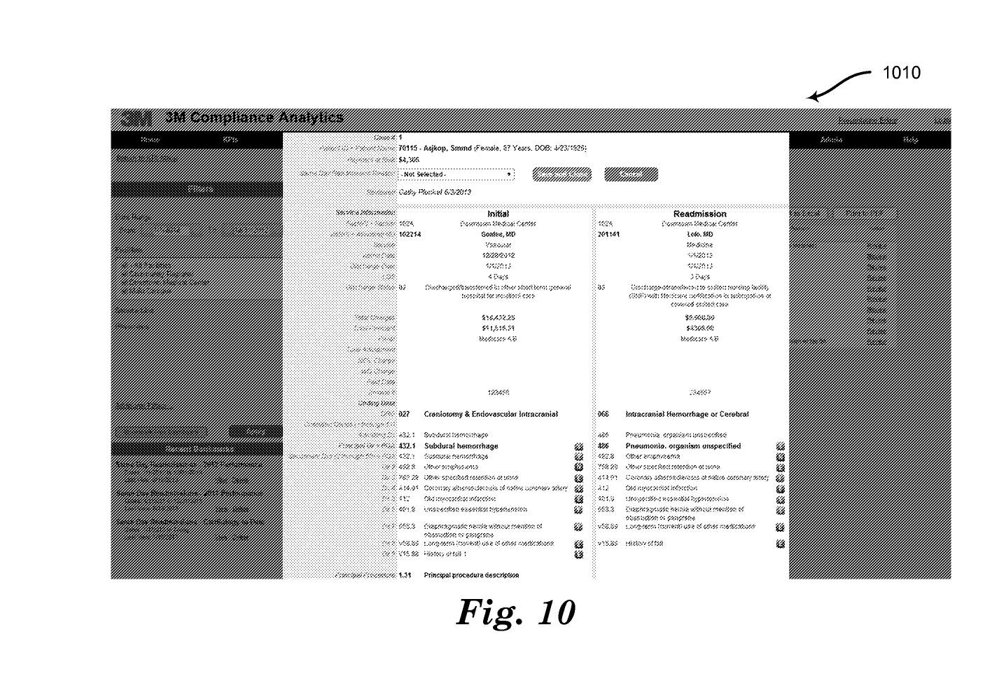

FIG. 10 shows a screenshot 1010 of a detailed analysis regarding billing codes linked to a single patient. Since the current techniques look across multiple records, an output of billing procedures and flags regarding a single patient can easily be compiled.

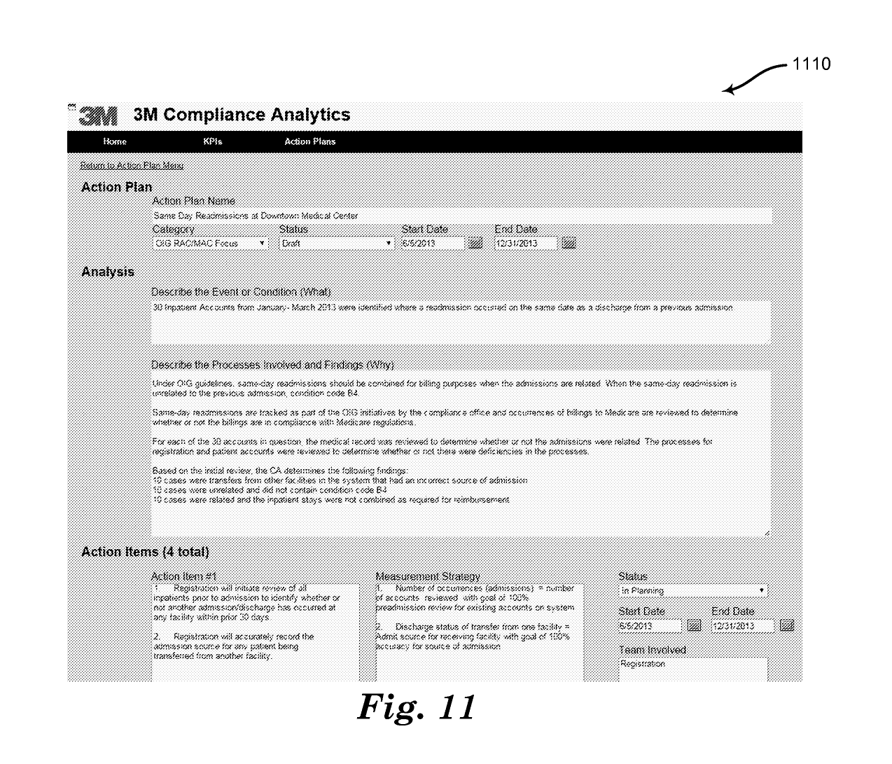

FIG. 11 shows a screenshot 1110 of a corrective action plan and analytical summary. Here, the corrective action plan is regarding same day readmissions at a particular hospital. The corrective action plan also has a list of action items for how to solve future instances of these problems. The analytical summary describes the event, the processes involved, the findings, and other various identifying categories, such as data and status.

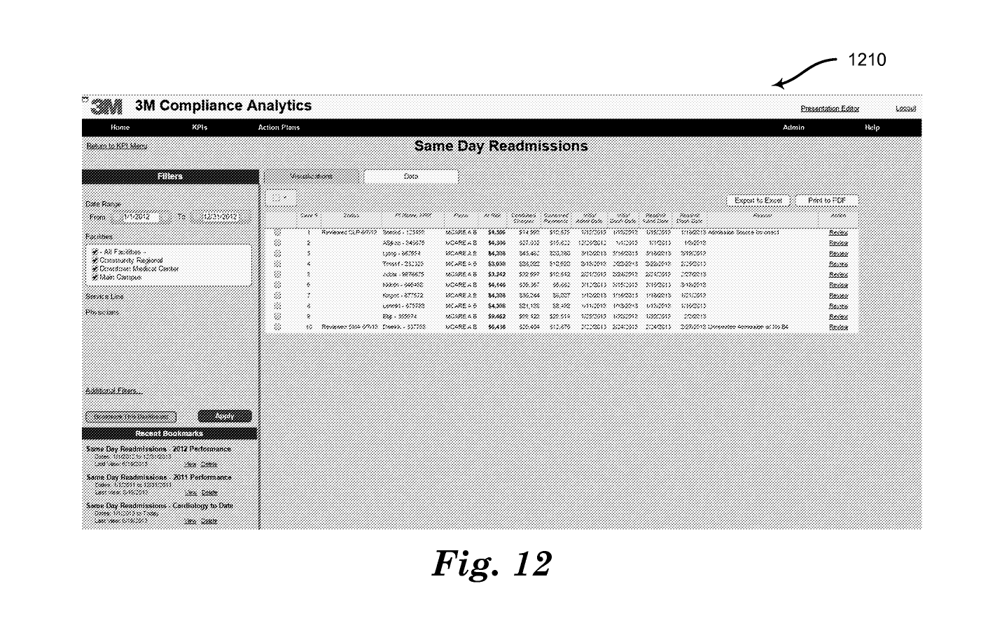

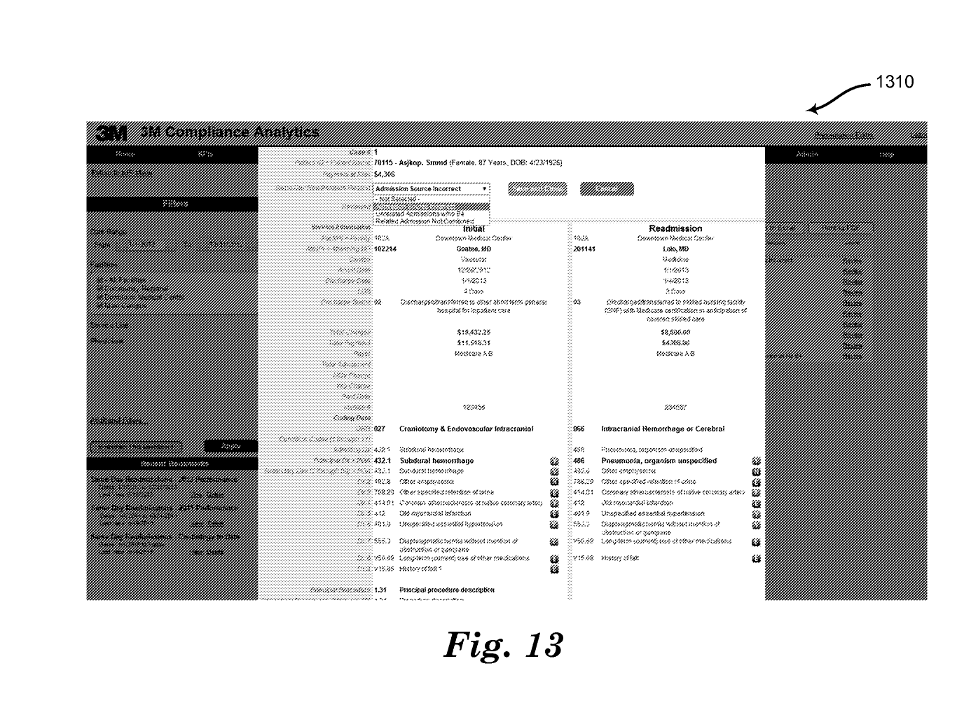

FIG. 12 shows a screenshot 1210 of a detailed analysis regarding a single type of billing code. Here, the code in question deals with same day readmissions, with a listing of various times that code was flagged, along with the result of what happened when that code was flagged. The reviewer will then access the system and their individual work list will be displayed. Upon selecting the record for review, the case summary analysis will appear, as shown in FIG. 13.

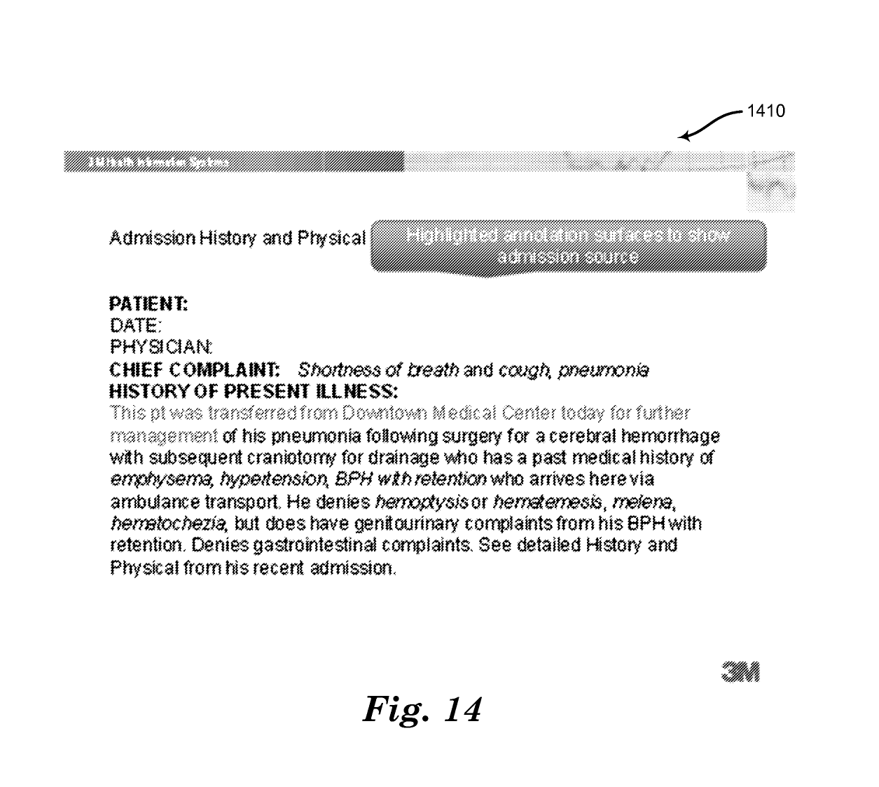

FIG. 13 shows a screenshot 1310 of a detailed analysis regarding billing codes linked to a single patient. Since the current techniques look across multiple records, an output of billing procedures and flags regarding a single patient can easily be compiled. The reviewer can then access the electronic medical record documentation associated with the case and the highlighted sections will be surfaced that relate to the issue detected, as shown in FIG. 14.

FIG. 14 shows a screenshot of a medical record where the highlighted portion annotates an admission source, where there is a discrepancy between where the patient was admitted and what the billing codes say regarding the source of admission. The system also features an application that provides a unique workflow for identifying, reviewing, and investigating potential health care non-compliant billing and coding processes and allows for creation of action plans and tracking resolution of issues.

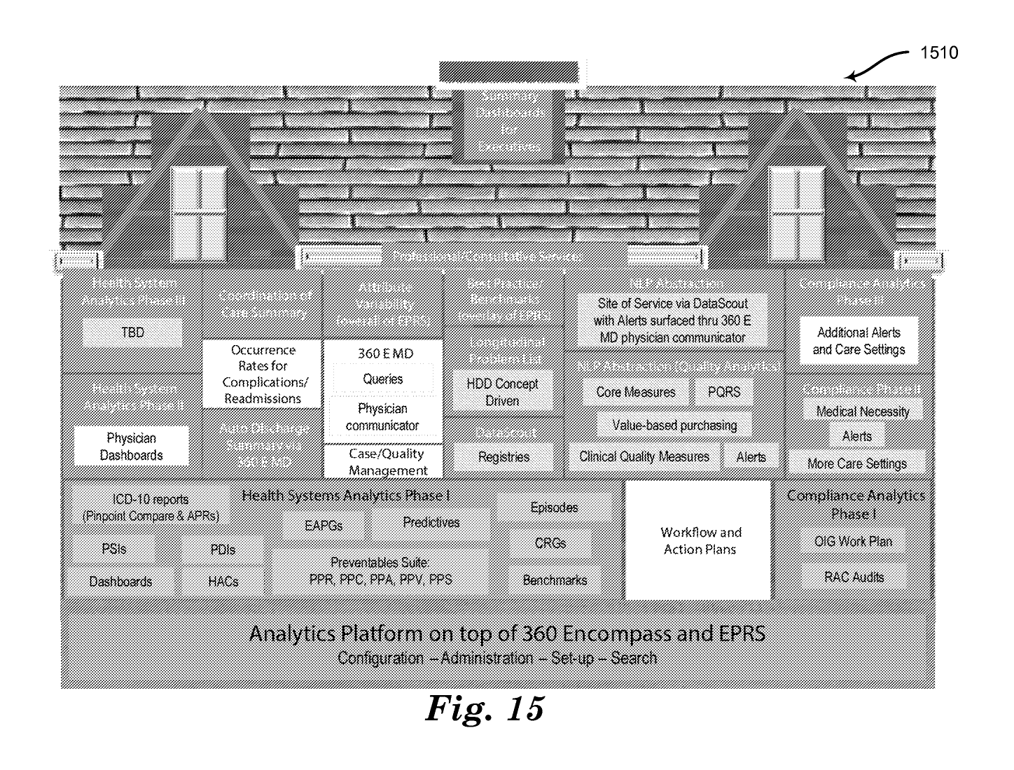

FIG. 15 is a block diagram of an analytics platform that implements methods of the current disclosure, in accordance with one or more techniques of the current disclosure. In diagram 1510, setups for various techniques in accordance with the current disclosure are shown. For instance, different services, such as health system analytics, coordination of care, automatic discharge summary, attribute variability, NLP abstraction, compliance analytics, and compliance phases.

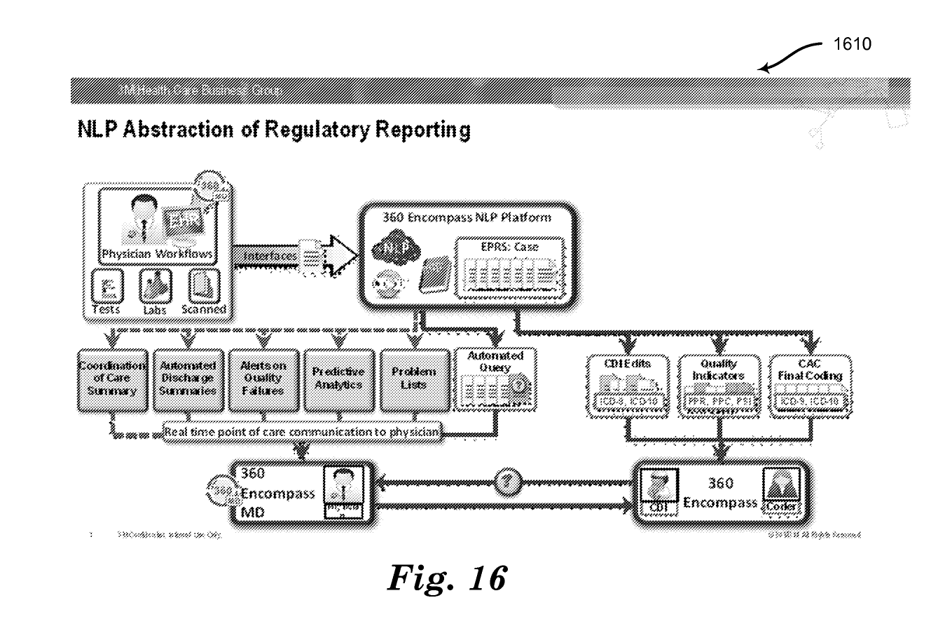

FIG. 16 is an abstraction of regulatory reporting, in accordance with one or more techniques of the current disclosure. FIG. 16 also shows a work flow that incorporates multiple techniques in accordance with the current disclosure. Medical professionals access the NLP platform, where they can edit medical records and administrative codes. Medical professionals can also access a coordination of care summary, automated discharge summaries, quality control failures, predictive analytics, and problem lists. These results can then be sent back to the medical professionals.

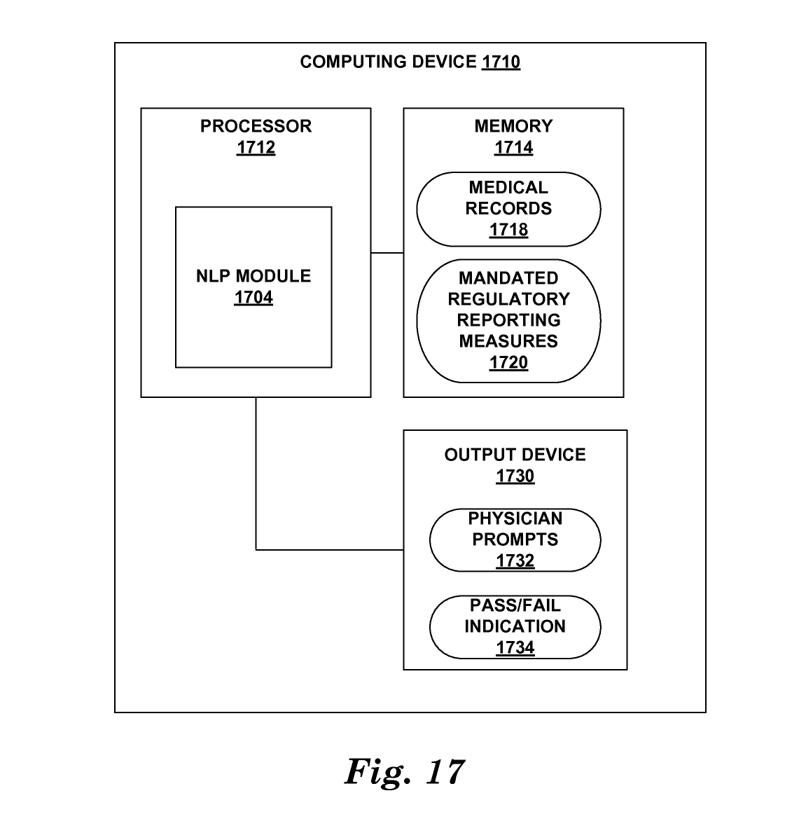

FIG. 17 is a block diagram illustrating an example of a standalone computing device for quality control, in accordance with one or more techniques of the current disclosure. Quality control can include core measures, value based purchasing, physician quality reporting services, joint commission requirements, clinical quality measures, patient safety indicators, pediatric quality indicators, neonatal quality indicators, never events, and hospital acquired conditions. Documents will be searched utilizing natural language processing to search structured and unstructured text to capture concepts created in a health data dictionary (HDD) to determine if criteria has been met for the mandated regulatory reporting measures. A pass/fail indication will be determined during real time review of documents and will present, to case management/utilization management or the physician which indicators in each measure have not been met providing the physician/case management/utilization management the ability to rectify, or document the contraindication for the required clinical care element. Data can then be extracted and sent to the provider outside approved reporting agency. The system comprises computing device 1710 that includes a processor 1712, a memory 1714, and an output device 1730. Computing device 1710 may also include many other components. The illustrated components are shown merely to explain various aspects of this disclosure. Computing device 1710 may be a desktop computer, a tablet computer, a personal digital assistant (PDA), a laptop computer, a portable media player, an e-book reader, a watch, a television platform, or another type of computing device.

The output device 1730 may comprise a display screen, although this disclosure is not necessarily limited in this respect, and other types of output devices may also be used. Memory 1714 stores medical records 1718, comprising textual and numeric information for a plurality of medical records, and mandated regulatory reporting measures 1720, comprising governmental guidelines that are required to be followed by medical professionals. Processor 1712 is configured to include an NLP module 1704 which executes techniques of this disclosure with respect to medical records 1718 and mandated regulatory reporting measures 1720.

Processor 1712 may comprise a general-purpose microprocessor, a specially designed processor, an application specific integrated circuit, a field programmable gate array, a collection of discrete logic, or any type of processing device capable of executing the techniques described herein. In one example, memory 1714 may store program instructions (e.g., software instructions) that are executed by processor 1712 to carry out the techniques described herein. In other examples, the techniques may be executed by specifically programmed circuitry of processor 1712. In these or other ways, processor 1712 may be configured to execute the techniques described herein.

Output device 1730 may comprise a display screen, and may also include other types of output capabilities. In some cases, output device 1730 may generally represent both a display screen and a printer in some cases. NLP module 1704 may be configured to cause output device 130 to output physician prompts 1732 and pass/fail indication 1734. Physician prompts 1732 may be generated, e.g., as output on a display screen, so as to allow a physician or other medical professional to indicate that the discrepancy indicated by NLP module 1704 was mistakenly found, has been rectified, or to give the physician the opportunity to explain why the guideline was not followed in this particular instance. Pass/fail indication 1734 may be generated, e.g., as output on a display screen, to indicate whether the mandated regulatory reporting measures 1720 have been followed in medical records 1718. These discrepancies may be an indication that the physician has not followed government-regulated protocol.

In one example, memory 1714 stores medical records 1718 and mandated regulatory reporting measures 1720. These could be stored in databases, data warehouses, in cloud data structures, or on a hard disk, among other things. Medical records 1718 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Mandated regulatory reporting measures 1720 could contain procedures and medication guidelines that must be followed when certain conditions and diagnoses are present in a patient's medical records.

NLP module 1704 is configured to associate different guidelines in mandated regulatory reporting measures 1720 to specific natural language meanings. NLP module 1704 translates the information contained in mandated regulatory reporting measures 1720 into those natural language meanings to describe what a patient was required to have been treated with during their encounter in the medical facility. NLP module 1704 then compares that information to medical records 1718, which should also give a natural language description of what a patient was administered during their encounter in the medical facility.

NLP module 1704 compares the information contained in medical records 1718 and the information contained in mandated regulatory reporting measures 1720 for a given procedure or diagnosis. NLP module 1704 may, in some examples, analyze the information contained in medical records 1718 and the information contained in administrative medical data 1720 by strictly comparing the two. In other examples, NLP module 1704 may use a natural language processing model to parse out particular keywords and synonyms for those keywords in the information contained in medical records 1718 and the information contained in mandated regulatory reporting measures 1720. NLP module 1704 may then compare those keywords and synonyms to reduce the number of false negatives incurred by the system by accounting for different terminologies used between different physicians and medical professionals or between a medical professional and the guidelines of mandated regulatory reporting measures 1720.

NLP module 1704 identifies one or more risks based on the comparison of the information contained in medical records 1718 with information contained in mandated regulatory reporting measures 1720 for a given procedure or diagnosis. If NLP module 1704 determines that the difference between the information contained in medical records 1718 and the information contained in mandated regulatory reporting measures 1720 for a given procedure or diagnosis may have led to an incorrect treatment of a patient, NLP module 1704 may identify that portion of medical records 1718 and mandated regulatory reporting measures 1720 as a fail indication. If the information in medical records 1718 is in line with the information in mandated regulatory reporting measures 1720 for a given procedure or diagnosis, then NLP module 1704 may identify a pass indication.

NLP module 1704 outputs information associated with the comparisons identified above in the form of physician prompts 1732 and pass/fail indication 1734. In some examples, the pass/fail indication 1734 and the information contained in medical records 1718 may be sent to an outside reporting agency. This may be done either electronically via the internet or some other form of network, or it may send this indication to a physical printer for mailing. NLP module 1704 may also, upon outputting a fail indication, prompt the user for an explanation of the fail indication or for a remedy of the fail indication.

In one embodiment, the disclosure is directed to a method for analyzing medical documentation. One or more computing devices stores a plurality of medical records and mandated regulatory reporting measures. The one or more computing devices compares information contained in the plurality of medical records with information contained in mandated regulatory reporting measures for a given procedure or diagnosis. The one or more computing devices identifies a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis. The one or more computing devices outputs the pass/fail indication.

The system of FIG. 17 is a standalone system in which processor 1712 that executed NLP module 1704 and output device 1730 that outputs physician prompts 1732 and pass/fail indication 1734 reside on the same computing device 1710. However, the techniques of this disclosure may also be performed in a distributed system that includes a server computing device and a client computing device. In this case, the client computing device may communicate with the server computing device via a network. The NLP module may reside on the server computing device, but the output device may reside on the client computing device. In this case, when the NLP module causes display prompts, the NLP module causes the output device of the client computing device to display the prompts, e.g., via commands or instructions communicated from the server computing device to the client computing device. The NLP module may simply avoid such commands or instructions if display of the prompts at the output device is avoided.

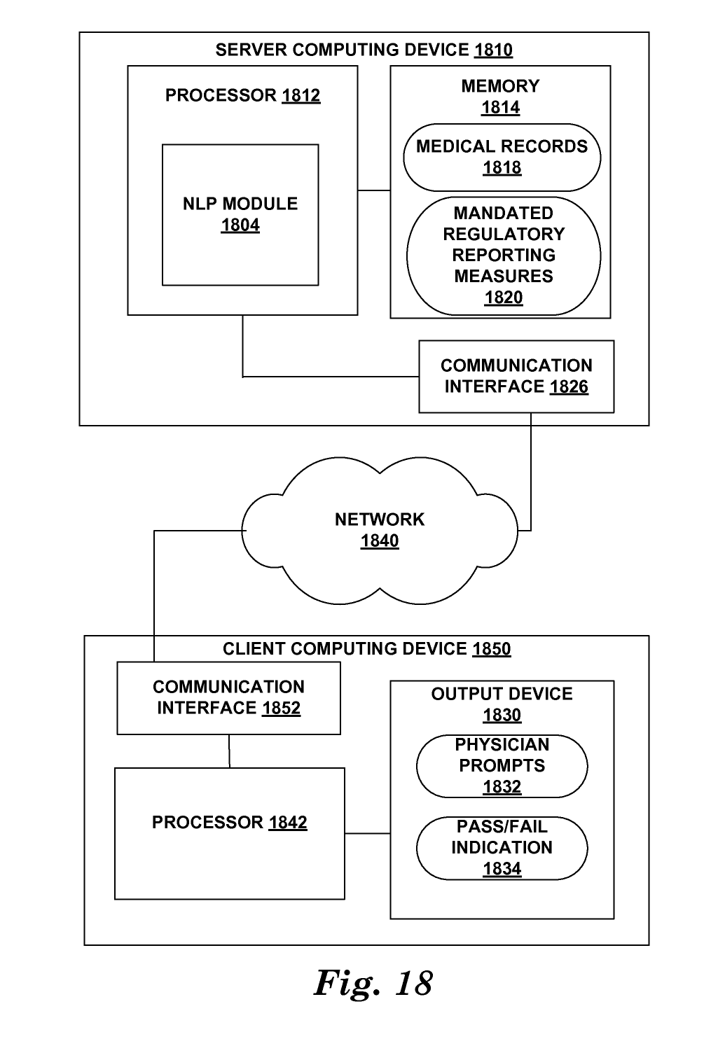

FIG. 18 is a block diagram illustrating an example of a distributed system for quality control, in accordance with one or more techniques of the current disclosure. This system includes a server computing device 1810 and a client computing device 1850 that communicate via a network 1840. In the example of FIG. 18, network 1840 may comprise a proprietary on non-proprietary network for packet-based communication. In one example, network 1840 comprises the Internet, in which case communication interfaces 1826 and 1852 may comprise interfaces for communicating data according to transmission control protocol/internet protocol (TCP/IP), user datagram protocol (UDP), or the like. More generally, however, network 1840 may comprise any type of communication network, and may support wired communication, wireless communication, fiber optic communication, satellite communication, or any type of techniques for transferring data between a source (e.g., server computing device 1810) and a destination (e.g., client computing device 1840).

Server computing device 1810 may perform the techniques of this disclosure, but a user may interact with the system via client computing device 1850. Server computing device 1810 may be implemented in a Cloud based environment. Server computing device 1810 may include a processor 1812, a memory 1814, and a communication interface 1826. Client computing device 1850 may include a communication interface 1852, a processor 1842 and an output device 1830. Of course, client computing device 1850 and server computing device 1810 may include many other components. The illustrated components are shown merely to explain various aspects of this disclosure.

Output device 1830 may comprise a display screen, although this disclosure is not necessarily limited in this respect and other output devices may also be used. Memory 1814 stores medical records 1818, comprising textual and numeric information for a plurality of medical records, and mandated regulatory reporting measures 1820, comprising governmental guidelines that are required to be followed by medical professionals. Processor 1812 is configured to include an NLP module 1804 which executes techniques of this disclosure with respect to medical records 1818 and mandated regulatory reporting measures 1820.

Processors 1812 and 1842 may each comprise a general-purpose microprocessor, a specially designed processor, an application specific integrated circuit, a field programmable gate array, a collection of discrete logic, or any type of processing device capable of executing the techniques described herein. In one example, memory 1814 may store program instructions (e.g., software instructions) that are executed by processor 1812 to carry out the techniques described herein. In other examples, the techniques may be executed by specifically programmed circuitry of processor 1812. In these or other ways, processor 1812 may be configured to execute the techniques described herein.

Output device 1830 on client computing device 1850 may comprise a display screen, and may also include other types of output capabilities. In some cases, output device 1830 may generally represent both a display screen and a printer in some cases. NLP module 1804 may be configured to cause output device 1830 of client computing device 1850 to output physician prompts 1832 and pass/fail indication 1834. Physician prompts 1832 may be generated, e.g., as output on a display screen, so as to allow a physician or other medical professional to indicate that the discrepancy indicated by NLP module 1804 was mistakenly found, has been rectified, or to give the physician the opportunity to explain why the guideline was not followed in this particular instance. Pass/fail indication 1834 may be generated, e.g., as output on a display screen, to indicate whether the mandated regulatory reporting measures 1820 have been followed in medical records 1818. These discrepancies may be an indication that the physician has not followed government-regulated protocol.

Similar to the standalone example of FIG. 17, in the distributed example of FIG. 18, in one example, memory 1814 stores medical records 1818 and mandated regulatory reporting measures 1820. These could be stored in databases, data warehouses, in a cloud data structure, or on a hard disk, among other things. Medical records 1818 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Mandated regulatory reporting measures 1820 could contain procedures and medication guidelines that must be followed when certain conditions are present in a patient's medical records.

NLP module 1804 is configured to associate different guidelines in mandated regulatory reporting measures 1820 to specific natural language meanings. NLP module 1804 translates the information contained in mandated regulatory reporting measures 1820 into those natural language meanings to describe what a patient was required to have been treated with during their encounter in the medical facility. NLP module 1804 then compares that information to medical records 1818, which should also give a natural language description of what a patient was administered during their encounter in the medical facility.

NLP module 1804 compares the information contained in medical records 1818 and the information contained in mandated regulatory reporting measures 1820 for a given procedure or diagnosis. NLP module 1804 may, in some examples, analyze the information contained in medical records 1818 and the information contained in administrative medical data 1820 by strictly comparing the two. In other examples, NLP module 1804 may use a natural language processing model to parse out particular keywords and synonyms for those keywords in the information contained in medical records 1818 and the information contained in mandated regulatory reporting measures 1820 for a given procedure or diagnosis. NLP module 1804 may then compare those keywords and synonyms to reduce the number of false negatives incurred by the system by accounting for different terminologies used between different physicians and medical professionals or between a medical professional and the guidelines of mandated regulatory reporting measures 1820.

NLP module 1804 identifies one or more risks based on the comparison of the information contained in medical records 1818 with information contained in mandated regulatory reporting measures 1820 for a given procedure or diagnosis. If NLP module 1804 determines that the difference between the information contained in medical records 1818 and the information contained in mandated regulatory reporting measures 1820 may have led to an incorrect treatment of a patient, NLP module 1804 may identify that portion of medical records 1818 and mandated regulatory reporting measures 1820 as a fail indication. If the information in medical records 1818 is in line with the information in mandated regulatory reporting measures 1820, then NLP module 1804 may identify a pass indication.

NLP module 1804 outputs, at output device 1830 of client computing device 1850, information associated with the comparisons identified above in the form of physician prompts 1832 and pass/fail indication 1834. In some examples, the pass/fail indication 1834 and the information contained in medical records 1818 may be sent to an outside reporting agency. This may be done either electronically via the internet or some other form of network, or it may send this indication to a physical printer for mailing. NLP module 1804 may also, upon outputting a fail indication, prompt the user for an explanation of the fail indication or for a remedy of the fail indication.

Communication interfaces 1826 and 1852 allow for communication between server computing device 1810 and client computing device 1850 via network 1840. In this way, NLP module 1804 may execute on server computing device 1810 but the output may appear on output device 1830 of client computing device 1850. A user operating on client computing device 1850 may log-on or otherwise access NLP module 1804 of server computing device 1810, such as via a web-interface operating on the Internet or a propriety network, or via a direct or dial-up connection between client computing device 1850 and server computing device 1810. In some cases, data displayed on output device 1830 may be arranged in web pages served from server computing device 1810 to client computing device 1850 via hypertext transfer protocol (HTTP), extended markup language (XML), or the like.

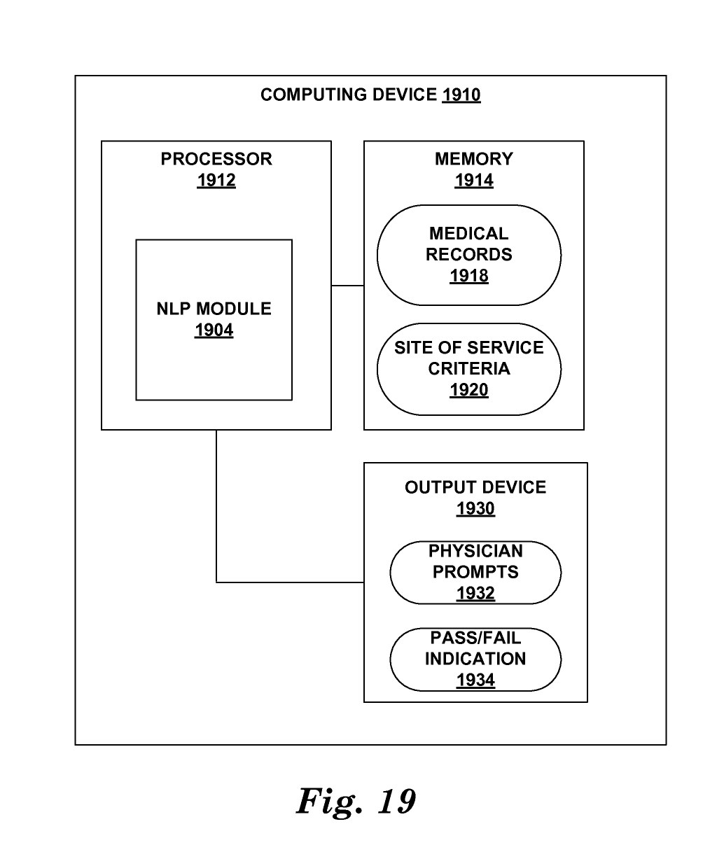

FIG. 19 is a block diagram illustrating an example of a standalone computing device for assessing site of service qualifications, in accordance with one or more techniques of the current disclosure. Site of service qualifications can include appropriate level of care for setting, inpatient, outpatient, observation, etc. Documents will be searched utilizing natural language processing to search structured and unstructured text to capture concepts created in a health data dictionary to determine if criteria has been met for the site of service criteria utilized by the client. Concepts captured will determine pass/fail during real time review of documents will present to case/utilization management or the physician which site of service assigned/criteria utilized has not been met providing the physician/case management/utilization management the ability to rectify the site of service and or document the additional information needed to meet the site of service assigned. The system comprises computing device 1910 that includes a processor 1912, a memory 1914, and an output device 1930. Computing device 1910 may also include many other components. The illustrated components are shown merely to explain various aspects of this disclosure. Computing device 1910 may be a desktop computer, a tablet computer, a personal digital assistant (PDA), a laptop computer, a portable media player, an e-book reader, a watch, a television platform, or another type of computing device.

The output device 1930 may comprise a display screen, although this disclosure is not necessarily limited in this respect, and other types of output devices may also be used. Memory 1914 stores medical records 1918, comprising textual and numeric information for a plurality of medical records, and site of service criteria 1920, comprising any of the following factors, either alone or in combination with one another: level of care needed, medical events, signs, symptoms, lab values, diagnostic results, specific care provided such as types of medical equipment, care unit, medications, treatments, ancillary services, and/or specific wards for placement. Processor 1912 is configured to include an NLP module 1904 which executes techniques of this disclosure with respect to medical records 1918 and site of service criteria 1920.

Processor 1912 may comprise a general-purpose microprocessor, a specially designed processor, an application specific integrated circuit, a field programmable gate array, a collection of discrete logic, or any type of processing device capable of executing the techniques described herein. In one example, memory 1914 may store program instructions (e.g., software instructions) that are executed by processor 1912 to carry out the techniques described herein. In other examples, the techniques may be executed by specifically programmed circuitry of processor 1912. In these or other ways, processor 1912 may be configured to execute the techniques described herein.

Output device 1930 may comprise a display screen, and may also include other types of output capabilities. In some cases, output device 1930 may generally represent both a display screen and a printer in some cases. NLP module 1904 may be configured to cause output device 1930 to output physician prompts 1932 and pass/fail indication 1934. Physician prompts 1932 may be generated, e.g., as output on a display screen, so as to allow a physician or other medical professional to indicate that the discrepancy indicated by NLP module 1904 was mistakenly found, has been rectified, or to give the physician the opportunity to explain why the guideline was not followed in this particular instance. Pass/fail indication 1934 may be generated, e.g., as output on a display screen, to indicate whether the site of service criteria 1920 have been followed in medical records 1918. These discrepancies may be an indication that the physician has not followed the given site of service criteria protocol.

In one example, memory 1914 stores medical records 1918 and site of service criteria 1920. These could be stored in databases, data warehouses, in cloud data structures, or on a hard disk, among other things. Medical records 1918 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Site of service criteria 1920 could contain any information relating to level of care, equipment needed for treatment, or a specific ward where the patient needs to be placed.

NLP module 1904 is configured to associate different levels in site of service criteria 1920 to specific natural language meanings. NLP module 1904 translates the information contained in site of service criteria 1920 into those natural language meanings to describe what a patient was charged for during their encounter in the medical facility. NLP module 1904 then compares that information to medical records 1918, which should also give a natural language description of what a patient was administered during their encounter in the medical facility.

NLP module 1904 compares the information contained in medical records 1918 and a portion the information contained in site of service criteria 1920 that corresponds to the patient's current site of service status in medical records 1918. NLP module 1904 may, in some examples, analyze the information contained in medical records 1918 and the information contained in site of service criteria 1920 by strictly comparing the two. In other examples, NLP module 1904 may use a natural language processing model to parse out particular keywords and synonyms for those keywords in the information contained in medical records 1918 and the information contained in site of service criteria 1920. NLP module 1904 may then compare those keywords and synonyms to reduce the number of false negatives incurred by the system by accounting for different terminologies used between different physicians and medical professionals or between a medical professional and the site of service criteria 1920.

NLP module 1904 identifies a pass/fail indication 1934 on the comparison of the information contained in medical records 1918 with information contained in the portion of the site of service criteria 1920. If NLP module 1904 determines that the difference between the information contained in medical records 1918 and the information contained in site of service criteria 1920 may have led to an error in patient placement, NLP module 1904 may identify that portion of medical records 1918 and as a failed indication.

NLP module 1904 outputs the pass/fail indication 1934. In some examples, NLP module 1904 further, upon outputting a fail indication, prompts the user for an explanation of the incorrect site of service status or a remedy of the fail indication.

In one embodiment, the disclosure is directed to a method for analyzing medical documentation. One or more computing devices store a plurality of medical records and site of service criteria. The one or more computing devices compare information contained in the plurality of medical records with a portion of information contained in the site of service criteria required for a site of service status in the plurality of medical records. The one or more computing devices identify a pass/fail indication based on the comparison of the information contained in the plurality of medical records with the portion of information contained in the site of service criteria based on whether the information contained in the plurality of medical records includes the portion of information contained in the set of site of service criteria. The one or more computing devices output the pass/fail indication.

The system of FIG. 19 is a standalone system in which processor 1912 that executed NLP module 1904 and output device 1930 that outputs physician prompts 1932 and pass/fail indication 1934 reside on the same computing device 1910. However, the techniques of this disclosure may also be performed in a distributed system that includes a server computing device and a client computing device. In this case, the client computing device may communicate with the server computing device via a network. The NLP module 1904 may reside on the server computing device, but the output device may reside on the client computing device. In this case, when the NLP module 1904 causes display prompts, the NLP module 1904 causes the output device of the client computing device to display the prompts, e.g., via commands or instructions communicated from the server computing device to the client computing device. The NLP module 1904 may simply avoid such commands or instructions if display of the prompts at the output device is avoided.

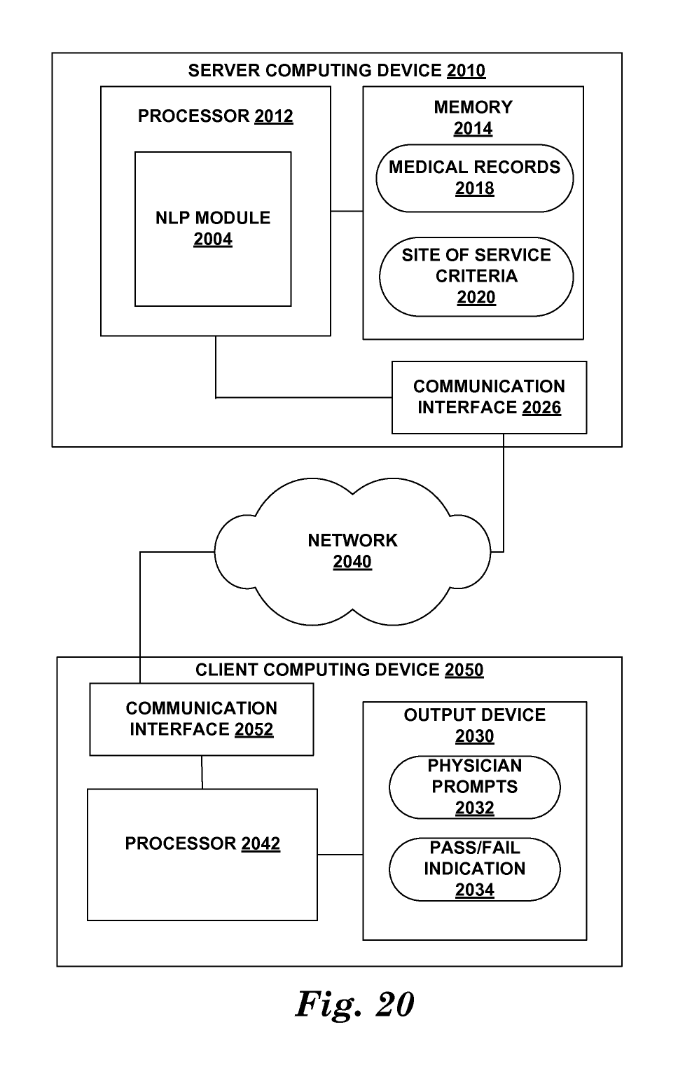

FIG. 20 is a block diagram illustrating an example of a distributed system for assessing site of service qualifications, in accordance with one or more techniques of the current disclosure. This system includes a server computing device 2010 and a client computing device 2050 that communicate via a network 2040. In the example of FIG. 20, network 2040 may comprise a proprietary on non-proprietary network for packet-based communication. In one example, network 2040 comprises the Internet, in which case communication interfaces 2026 and 2052 may comprise interfaces for communicating data according to transmission control protocoVinternet protocol (TCP/IP), user datagram protocol (UDP), or the like. More generally, however, network 2040 may comprise any type of communication network, and may support wired communication, wireless communication, fiber optic communication, satellite communication, or any type of techniques for transferring data between a source (e.g., server computing device 2010) and a destination (e.g., client computing device 2040).

Server computing device 2010 may perform the techniques of this disclosure, but a user may interact with the system via client computing device 2050. Server computing device 2010 may be implemented in a Cloud based environment. Server computing device 2010 may include a processor 2012, a memory 2014, and a communication interface 2026. Client computing device 2050 may include a communication interface 2052, a processor 2042 and an output device 2030. Of course, client computing device 2050 and server computing device 2010 may include many other components. The illustrated components are shown merely to explain various aspects of this disclosure.

Output device 2030 may comprise a display screen, although this disclosure is not necessarily limited in this respect and other output devices may also be used. Memory 2014 stores medical records 2018, comprising textual and numeric information for a plurality of medical records, and site of service criteria 2020, comprising any of the following factors, either alone or in combination with one another: level of care needed, types of medical equipment needed for treatment, and/or specific wards for placement. Processor 2012 is configured to include an NLP module 2004 which executes techniques of this disclosure with respect to medical records 2018 and site of service criteria 2020.

Processors 2012 and 2042 may each comprise a general-purpose microprocessor, a specially designed processor, an application specific integrated circuit, a field programmable gate array, a collection of discrete logic, or any type of processing device capable of executing the techniques described herein. In one example, memory 2014 may store program instructions (e.g., software instructions) that are executed by processor 2012 to carry out the techniques described herein. In other examples, the techniques may be executed by specifically programmed circuitry of processor 2012. In these or other ways, processor 2012 may be configured to execute the techniques described herein.

Output device 2030 on client computing device 2050 may comprise a display screen, and may also include other types of output capabilities. In some cases, output device 2030 may generally represent both a display screen and a printer in some cases. NLP module 2004 may be configured to cause output device 2030 of client computing device 2050 to output physician prompts 2032 and pass/fail indication 2034. Physician prompts 2032 may be generated, e.g., as output on a display screen, so as to allow a physician or other medical professional to indicate that the discrepancy indicated by NLP module 2004 was mistakenly found, has been rectified, or to give the physician the opportunity to explain why the guideline was not followed in this particular instance. Pass/fail indication 2034 may be generated, e.g., as output on a display screen, to indicate whether the site of service criteria 2020 have been followed in medical records 2018. These discrepancies may be an indication that the physician has not followed the given site of service criteria protocol.

Similar to the standalone example of FIG. 19, in the distributed example of FIG. 20, in one example, memory 2014 stores medical records 2018 and site of service criteria 2020. These could be stored in databases, data warehouses, in a cloud data structure or on a hard disk, among other things. Medical records 2018 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Site of service criteria 2020 could contain any information relating to level of care, medical events, signs, symptoms, lab values, diagnostic results, specific care provided such as types of medical equipment, care unit, medications, treatments, ancillary services, or a specific ward where the patient needs to be placed.

NLP module 2004 is configured to different levels in site of service criteria 2020 to specific natural language meanings. NLP module 2004 translates the information contained in site of service criteria 2020 into those natural language meanings to describe what a patient was charged for during their encounter in the medical facility. NLP module 2004 then compares that information to medical records 2018, which should also give a natural language description of what a patient was administered during their encounter in the medical facility.

NLP module 2004 compares the information contained in medical records 2018 and a portion the information contained in site of service criteria 2020 that corresponds to the patient's current site of service status in medical records 2018. NLP module 2004 may, in some examples, analyze the information contained in medical records 2018 and the information contained in site of service criteria 2020 by strictly comparing the two. In other examples, NLP module 2004 may use a natural language processing model to parse out particular keywords and synonyms for those keywords in the information contained in medical records 2018 and the information contained in site of service criteria 2020. NLP module 2004 may then compare those keywords and synonyms to reduce the number of false negatives incurred by the system by accounting for different terminologies used between different physicians and medical professionals or between a medical professional and the site of service criteria 2020.

NLP module 2004 identifies a pass/fail indication 2034 on the comparison of the information contained in medical records 2018 with information contained in the portion of the site of service criteria 2020. If NLP module 2004 determines that the difference between the information contained in medical records 2018 and the information contained in site of service criteria 2020 may have led to an error in patient placement, NLP module 2004 may identify that portion of medical records 2018 and as a failed indication.

NLP module 2004 outputs, at output device 2030 of client computing device 2050, the pass/fail indication 2034. In some examples, NLP module 2004 further, upon outputting a fail indication, prompts the user for an explanation of the incorrect site of service status or a remedy of the fail indication.

Communication interfaces 2026 and 2052 allow for communication between server computing device 2010 and client computing device 2050 via network 2040. In this way, NLP module 2004 may execute on server computing device 2010 but the output may appear on output device 2030 of client computing device 2050. A user operating on client computing device 2050 may log-on or otherwise access NLP module 2004 of server computing device 2010, such as via a web-interface operating on the Internet or a propriety network, or via a direct or dial-up connection between client computing device 2050 and server computing device 2010. In some cases, data displayed on output device 2030 may be arranged in web pages served from server computing device 2010 to client computing device 2050 via hypertext transfer protocol (HTTP), extended markup language (XML), or the like.

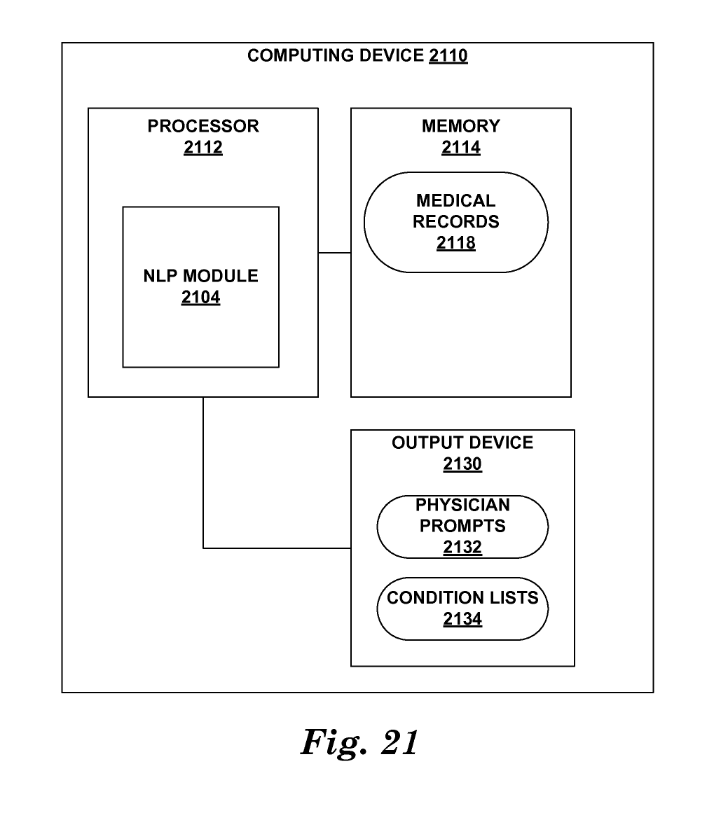

FIG. 21 is a block diagram illustrating an example of a standalone computing device for identifying chronic patient conditions, in accordance with one or more techniques of the current disclosure. Problem Lists are typically manually created by the physician for meaningful use requirements. Previous encounters/admissions of each patient will be searched and a longitudinal problem list created from the final coded data, then custom logic will review and merge like diagnoses to the most specific conditions found in the patient history. Natural language processing will then be utilized to identify chronic conditions versus one time medical issues and the auto-generated problem list will and can be reviewed by the physician as part of the encounter and visit. As the physician enters new information into the encounter/admission, the problem list will be updated by NLP as the physician adds/documents new conditions to in the record. This will then be surfaced to the physician for review, editing and approval. Throughout the encounter or admission, NLP will continually update the problem list with new diagnoses and be available for review and updating by the physician through discharge. Utilizing logic will define the conditions by the highest degree of specificity known to prevent duplications of diseases and the conditions will be coded and or translated to ICD-9, ICD-10, Snomed®, CPT®. The system comprises computing device 2110 that includes a processor 2112, a memory 2114, and an output device 2130. Computing device 2110 may also include many other components. The illustrated components are shown merely to explain various aspects of this disclosure. Computing device 2110 may be a desktop computer, a tablet computer, a personal digital assistant (PDA), a laptop computer, a portable media player, an e-book reader, a watch, a television platform, or another type of computing device.

The output device 2130 may comprise a display screen, although this disclosure is not necessarily limited in this respect, and other types of output devices may also be used. Memory 2114 stores medical records 2118, comprising textual and numeric information for a plurality of medical records for a single patient. Processor 2112 is configured to include an NLP module 2104 which executes techniques of this disclosure with respect to medical records 2118.

Processor 2112 may comprise a general-purpose microprocessor, a specially designed processor, an application specific integrated circuit, a field programmable gate array, a collection of discrete logic, or any type of processing device capable of executing the techniques described herein. In one example, memory 2114 may store program instructions (e.g., software instructions) that are executed by processor 2112 to carry out the techniques described herein. In other examples, the techniques may be executed by specifically programmed circuitry of processor 2112. In these or other ways, processor 2112 may be configured to execute the techniques described herein.

Output device 2130 may comprise a display screen, and may also include other types of output capabilities. In some cases, output device 2130 may generally represent both a display screen and a printer in some cases. NLP module 2104 may be configured to cause output device 2130 to output physician prompts 2132 and condition lists 2134. Physician prompts 2132 may be generated, e.g., as output on a display screen, so as to allow a physician or other medical professional to add or modify portions of condition lists 2134. Condition lists 2134 may be generated, e.g., as output on a display screen, to indicate specific conditions and diagnoses that a patient has been given throughout their lifetime, according to medical records 2118, and whether these conditions are chronic conditions or one-time medical conditions.

In one example, memory 2114 stores medical records 2118. These could be stored in databases, data warehouses, in cloud data structures, or on a hard disk, among other things. Medical records 2118 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter.

NLP module 2104 is configured to analyze medical records 2118, which should give a natural language description of what a patient was administered during their encounter in the medical facility. NLP module 2104 analyzes the information in medical records 2118 to detect the number of instances that a condition arises in a patient's medical history, as well as a time consideration for the condition.

NLP module 2104 may, in some examples, analyze the information contained in medical records 2118 by strictly comparing the instances. In other examples, NLP module 2104 may use a natural language processing model to parse out particular keywords and synonyms for those keywords in the information contained in medical records 2118. NLP module 2104 may then compare those keywords and synonyms to reduce the number of false negatives incurred by the system by accounting for different terminologies used between different physicians and medical professionals.

NLP module 2104 identifies a list of chronic conditions and a list of one-time medical conditions based on the analysis of the information contained in medical records 2118. If NLP module 2104 determines that a condition is chronic, a medical professional may take different measures in treating the condition than they may have taken if it was a one-time medical condition.

NLP module 2104 outputs the lists identified above in the form of physician prompts 2132 and condition lists 2134. In some examples, medical records 2118 can be dynamically updated throughout a single visit and the list of chronic conditions for the patient and the list of one-time medical conditions for the patient can be updated on each instance of the plurality of medical records being updated. In some examples, NLP module 2104 can further prompt a physician for a review and approval of the output, wherein the physician has the ability to edit the output using physician prompts 2132.

In one embodiment, the disclosure is directed to a method for analyzing medical documentation. One or more computing devices store a plurality of medical records for a single patient. The one or more computing devices analyze information contained in the plurality of medical records. The one or more computing devices identifies a list of chronic conditions for the patient and a list of one-time medical conditions for the patient based on a number of instances the patient has sought medical attention for the given conditions. The one or more computing devices outputs the list of chronic conditions for the patient and the list of one-time medical conditions for the patient.

The system of FIG. 21 is a standalone system in which processor 2112 that executed NLP module 2104 and output device 2130 that outputs physician prompts 2132 and condition lists 2134 reside on the same computing device 2110. However, the techniques of this disclosure may also be performed in a distributed system that includes a server computing device and a client computing device. In this case, the client computing device may communicate with the server computing device via a network. The NLP module may reside on the server computing device, but the output device may reside on the client computing device. In this case, when the NLP module causes display prompts, the NLP module causes the output device of the client computing device to display the prompts, e.g., via commands or instructions communicated from the server computing device to the client computing device. The NLP module may simply avoid such commands or instructions if display of the prompts at the output device is avoided.

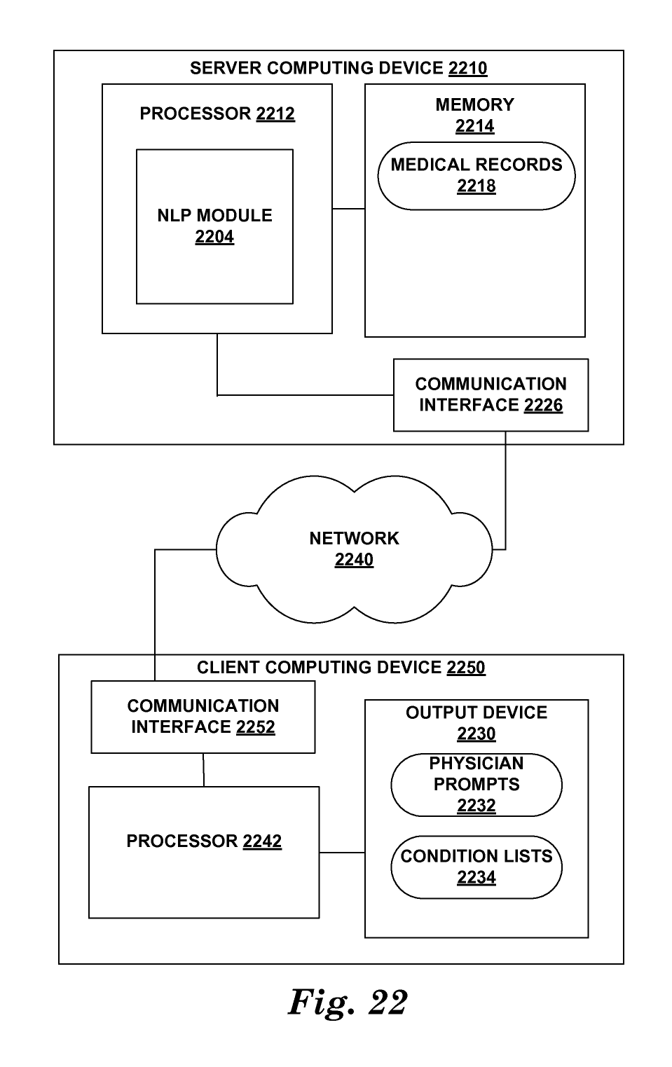

FIG. 22 is a block diagram illustrating an example of a distributed system for identifying chronic patient conditions, in accordance with one or more techniques of the current disclosure. This system includes a server computing device 2210 and a client computing device 2250 that communicate via a network 2240. In the example of FIG. 22, network 2240 may comprise a proprietary on non-proprietary network for packet-based communication. In one example, network 2240 comprises the Internet, in which case communication interfaces 2226 and 2252 may comprise interfaces for communicating data according to transmission control protocoVinternet protocol (TCP/IP), user datagram protocol (UDP), or the like. More generally, however, network 2240 may comprise any type of communication network, and may support wired communication, wireless communication, fiber optic communication, satellite communication, or any type of techniques for transferring data between a source (e.g., server computing device 2210) and a destination (e.g., client computing device 2240).

Server computing device 2210 may perform the techniques of this disclosure, but a user may interact with the system via client computing device 2250. Server computing device 2210 may be implemented in a Cloud based environment. Server computing device 2210 may include a processor 2212, a memory 2214, and a communication interface 2226. Client computing device 2250 may include a communication interface 2252, a processor 2242 and an output device 2230. Of course, client computing device 2250 and server computing device 2210 may include many other components. The illustrated components are shown merely to explain various aspects of this disclosure.

Output device 2230 may comprise a display screen, although this disclosure is not necessarily limited in this respect and other output devices may also be used. Memory 2214 stores medical records 2218, comprising textual and numeric information for a plurality of medical records for a single patient. Processor 2212 is configured to include an NLP module 2204 which executes techniques of this disclosure with respect to medical records 2218.

Processors 2212 and 2242 may each comprise a general-purpose microprocessor, a specially designed processor, an application specific integrated circuit, a field programmable gate array, a collection of discrete logic, or any type of processing device capable of executing the techniques described herein. In one example, memory 2214 may store program instructions (e.g., software instructions) that are executed by processor 2212 to carry out the techniques described herein. In other examples, the techniques may be executed by specifically programmed circuitry of processor 2212. In these or other ways, processor 2212 may be configured to execute the techniques described herein.

Output device 2230 on client computing device 2250 may comprise a display screen, and may also include other types of output capabilities. In some cases, output device 2230 may generally represent both a display screen and a printer in some cases. NLP module 2204 may be configured to cause output device 2230 of client computing device 2250 to output physician prompts 2232 and condition lists 2234. Physician prompts 2232 may be generated, e.g., as output on a display screen, so as to allow a physician or other medical professional to add or modify portions of condition lists 2234. Condition lists 2234 may be generated, e.g., as output on a display screen, to indicate specific conditions and diagnoses that a patient has been given throughout their lifetime, according to medical records 2218, and whether these conditions are chronic conditions or one-time medical conditions.

Similar to the standalone example of FIG. 21, in the distributed example of FIG. 22, in one example, memory 2214 stores medical records 2218. These could be stored in databases, data warehouses, in a cloud data structure, or on a hard disk, among other things. Medical records 2218 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter.

NLP module 2204 is configured to analyze medical records 2218, which should give a natural language description of what a patient was administered during their encounter in the medical facility. NLP module 2204 analyzes the information in medical records 2218 to detect the number of instances that a condition arises in a patient's medical history, as well as a time consideration for the condition.

NLP module 2204 may, in some examples, analyze the information contained in medical records 2218 by strictly comparing the instances. In other examples, NLP module 2204 may use natural language processing to parse out particular keywords and synonyms for those keywords in the information contained in medical records 2218. NLP module 2204 may then compare those keywords and synonyms to reduce the number of false negatives incurred by the system by accounting for different terminologies used between different physicians and medical professionals.

NLP module 2204 identifies a list of chronic conditions and a list of one-time medical conditions based on the analysis of the information contained in medical records 2218. If NLP module 2204 determines that a condition is chronic, a medical professional may take different measures in treating the condition than they may have taken if it was a one-time medical condition.

NLP module 2204 outputs, at output device 2230 of client computing device 2250, the lists identified above in the form of physician prompts 2232 and condition lists 2234. In some examples, medical records 2218 can be dynamically updated throughout a single visit and the list of chronic conditions for the patient and the list of one-time medical conditions for the patient can be updated on each instance of the plurality of medical records being updated. In some examples, NLP module 2204 can further prompt a physician for a review and approval of the output, wherein the physician has the ability to edit the output using physician prompts 2232.

Communication interfaces 2226 and 2252 allow for communication between server computing device 2210 and client computing device 2250 via network 2240. In this way, NLP module 2204 may execute on server computing device 2210 but the output may appear on output device 2230 of client computing device 2250. A user operating on client computing device 2250 may log-on or otherwise access NLP module 2204 of server computing device 2210, such as via a web-interface operating on the Internet or a propriety network, or via a direct or dial-up connection between client computing device 2250 and server computing device 2210. In some cases, data displayed on output device 2230 may be arranged in web pages served from server computing device 2210 to client computing device 2250 via hypertext transfer protocol (HTTP), extended markup language (XML), or the like.

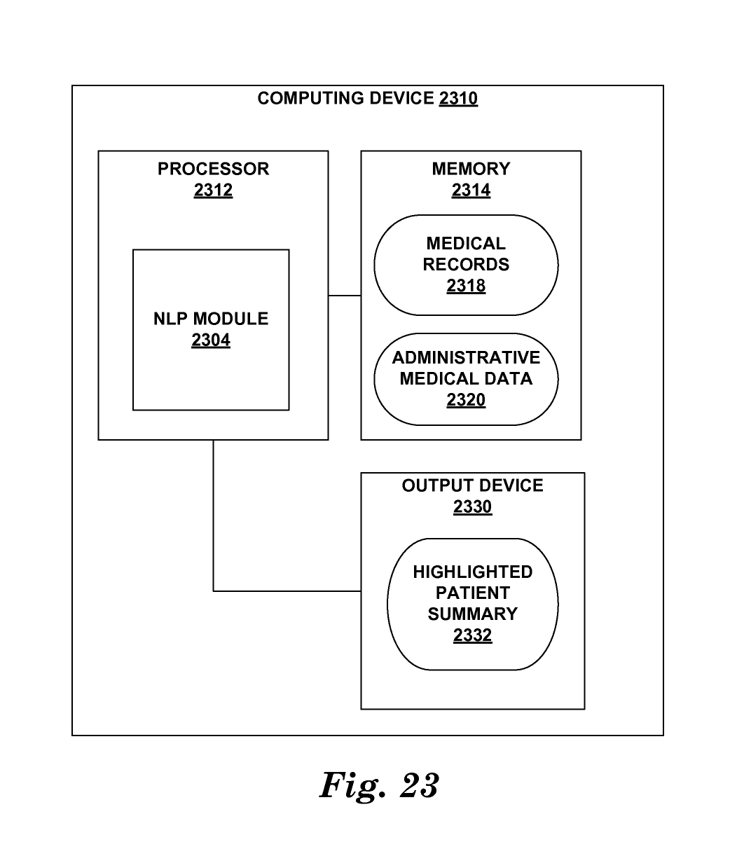

FIG. 23 is a block diagram illustrating an example of a standalone computing device for coordination of care, in accordance with one or more techniques of the current disclosure. Coordination of care is needed because it is difficult to see care delivered if a healthcare system does not have same EHR in facility, ambulatory or physician offices, which impacts the ability of the physician to coordinate and provide care. Previous encounters/admissions of each patient will be searched and a longitudinal problem list created from the final coded data, along with abstraction of encounters, visits, admissions, surgeries including date of visit, physician, diagnoses, procedures performed, key components of care delivered such as Vaccines, Diagnostic studies such as Echocardiograms, EKGs, Xrays, Colonoscopies, Mammograms, Pap Smears, HgbA1C, Lab values, etc.) to allow physician to see summary of care on a single patient without having to open multiple EHRs to get the information. Using NLP, and the documents in EPRS, the system provides the ability to link directly back to the document to see results without having to enter the multiple EMRs to view. The system comprises computing device 2310 that includes a processor 2312, a memory 2314, and an output device 2330. Computing device 2310 may also include many other components. The illustrated components are shown merely to explain various aspects of this disclosure. Computing device 2310 may be a desktop computer, a tablet computer, a personal digital assistant (PDA), a laptop computer, a portable media player, an e-book reader, a watch, a television platform, or another type of computing device.

The output device 2330 may comprise a display screen, although this disclosure is not necessarily limited in this respect, and other types of output devices may also be used. Memory 2314 stores medical records 2318, comprising textual and numeric information for a plurality of medical records, and administrative medical data 2320, comprising coded medical procedures. Processor 2312 is configured to include an NLP module 2304 which executes techniques of this disclosure with respect to medical records 2318 and administrative medical data 2320.

Processor 2312 may comprise a general-purpose microprocessor, a specially designed processor, an application specific integrated circuit, a field programmable gate array, a collection of discrete logic, or any type of processing device capable of executing the techniques described herein. In one example, memory 2314 may store program instructions (e.g., software instructions) that are executed by processor 2312 to carry out the techniques described herein. In other examples, the techniques may be executed by specifically programmed circuitry of processor 2312. In these or other ways, processor 2312 may be configured to execute the techniques described herein.

Output device 2330 may comprise a display screen, and may also include other types of output capabilities. In some cases, output device 2330 may generally represent both a display screen and a printer in some cases. NLP module 2304 may be configured to cause output device 2330 to output condensed patient summary 2332. Condensed patient summary 2332 may be generated, e.g., as output on a display screen, so as to allow a physician or other medical professional to easily see what procedures a patient has had conducted and what medications they have been given, whether it be by the same medical professional or a different medical professional. A condensed patient summary may comprise at least one of a date of visit, a physician name, a diagnoses list, a medication list, a procedure performed, a test, a test result, a vaccination, a diagnostic study, a body scan, coded medical data, or translations of coded medical data.

In one example, memory 2314 stores medical records 2318 and administrative medical data 2320. These could be stored in databases, data warehouses, in cloud data structures, or on a hard disk, among other things. Medical records 2318 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 2320 could contain codes pertaining to charge data and costs that will be billed to a payer, such as the government or an insurance company, although the techniques of this disclosure may apply to other payers.

NLP module 2304 is configured to associate different codes in administrative medical data 2320 to specific natural language meanings. NLP module 2304 translates the information contained in administrative medical data 2320 into those natural language meanings to describe what a patient was charged for during their encounter in the medical facility. NLP module 2304 then analyzes that information along with the medical records 2318, which should also give a natural language description of what a patient was administered during their encounter in the medical facility.

NLP module 2304 analyzes the information contained in medical records 2318 and the information contained in administrative medical data 2320. NLP module 2304 may, in some examples, analyze the information contained in medical records 2318 and the information contained in administrative medical data 2320 by strictly comparing the two. In other examples, NLP module 2304 may use a natural language processing model to parse out particular keywords and synonyms for those keywords in the information contained in medical records 2318 and the information contained in administrative medical data 2320. NLP module 2304 may then compare those keywords and synonyms to reduce the number of false negatives incurred by the system by accounting for different terminologies used between different physicians and medical professionals or between a medical professional and the codes of administrative medical data 2320.

NLP module 2304 assembles a condensed patient summary 2332 based on the analysis of the information contained in medical records 2318 and information contained in coded administrative data 2320. The condensed patient summary 2332 contains information about all of the procedures done on a patient so that medical professionals can better coordinate care rather than risk the possibility of administering a medication or a test multiple times.

NLP module 2304 outputs the condensed patient summary 2332. In some examples, medical records 2318 may be entered by more than one different physician or medical specialist, allowing the care to be coordinated and for condensed patient summary 2332 to contain a collaboration of material.

In one embodiment, the disclosure is directed to a method for analyzing medical documentation. One or more computing devices store a plurality of medical records and coded administrative data. The one or more computing devices analyze information contained in the plurality of medical records and information contained in coded administrative data. The one or more computing devices assemble a condensed patient summary based on the information contained in the plurality of medical records and the information contained in the coded administrative data. The one or more computing devices output the condensed patient summary.

The system of FIG. 23 is a standalone system in which processor 2312 that executed NLP module 2304 and output device 2330 that outputs condensed patient summary 2332 reside on the same computing device 2310. However, the techniques of this disclosure may also be performed in a distributed system that includes a server computing device and a client computing device. In this case, the client computing device may communicate with the server computing device via a network. The NLP module may reside on the server computing device, but the output device may reside on the client computing device. In this case, when the NLP module causes display prompts, the NLP module causes the output device of the client computing device to display the prompts, e.g., via commands or instructions communicated from the server computing device to the client computing device. The NLP module may simply avoid such commands or instructions if display of the prompts at the output device is avoided.

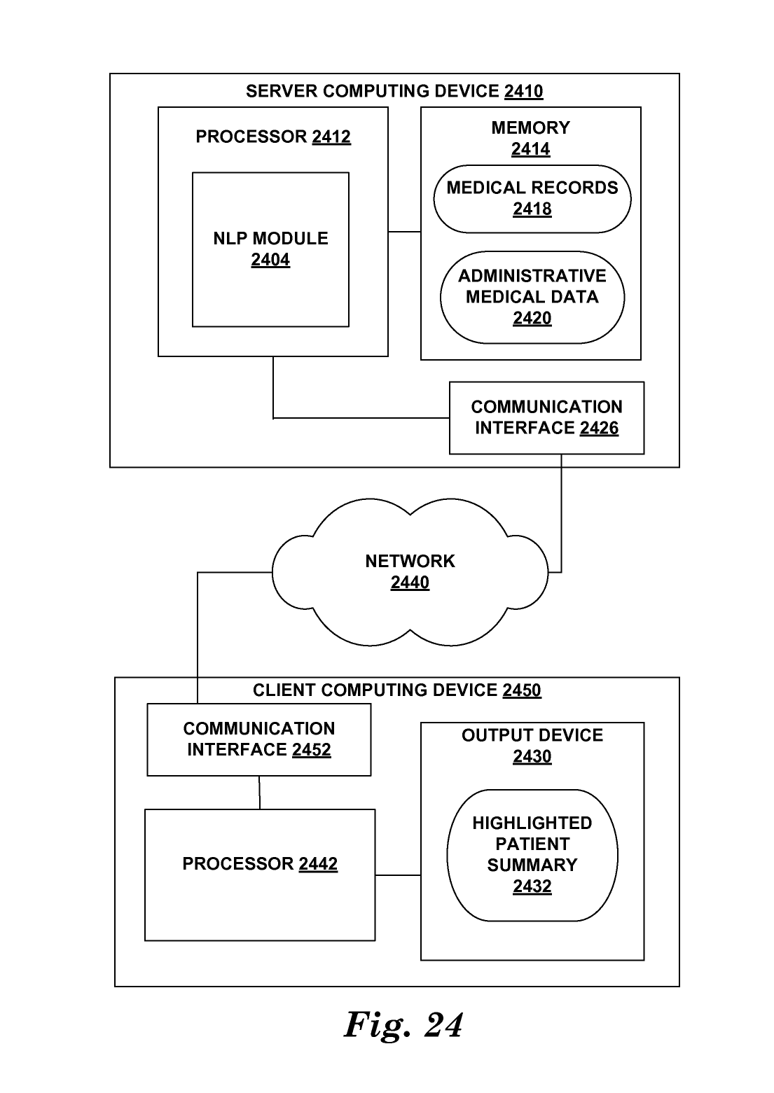

FIG. 24 is a block diagram illustrating an example of a distributed system for coordination of care, in accordance with one or more techniques of the current disclosure. This system includes a server computing device 2410 and a client computing device 2450 that communicate via a network 2440. In the example of FIG. 24, network 2440 may comprise a proprietary on non-proprietary network for packet-based communication. In one example, network 2440 comprises the Internet, in which case communication interfaces 2426 and 2452 may comprise interfaces for communicating data according to transmission control protocol/internet protocol (TCP/IP), user datagram protocol (UDP), or the like. More generally, however, network 2440 may comprise any type of communication network, and may support wired communication, wireless communication, fiber optic communication, satellite communication, or any type of techniques for transferring data between a source (e.g., server computing device 2410) and a destination (e.g., client computing device 2440).

Server computing device 2410 may perform the techniques of this disclosure, but a user may interact with the system via client computing device 2450. Server computing device 2410 may be implemented in a Cloud based environment. Server computing device 2410 may include a processor 2412, a memory 2414, and a communication interface 2426. Client computing device 2450 may include a communication interface 2452, a processor 2442 and an output device 2430. Of course, client computing device 2450 and server computing device 2410 may include many other components. The illustrated components are shown merely to explain various aspects of this disclosure.

Output device 2430 may comprise a display screen, although this disclosure is not necessarily limited in this respect and other output devices may also be used. Memory 2414 stores medical records 2418, comprising textual and numeric information for a plurality of medical records, and administrative medical data 2420, comprising coded medical procedures. Processor 2412 is configured to include an NLP module 2404 which executes techniques of this disclosure with respect to medical records 2418 and administrative medical data 2420.

Processors 2412 and 2442 may each comprise a general-purpose microprocessor, a specially designed processor, an application specific integrated circuit, a field programmable gate array, a collection of discrete logic, or any type of processing device capable of executing the techniques described herein. In one example, memory 2414 may store program instructions (e.g., software instructions) that are executed by processor 2412 to carry out the techniques described herein. In other examples, the techniques may be executed by specifically programmed circuitry of processor 2412. In these or other ways, processor 2412 may be configured to execute the techniques described herein.

Output device 2430 on client computing device 2450 may comprise a display screen, and may also include other types of output capabilities. In some cases, output device 2430 may generally represent both a display screen and a printer in some cases. NLP module 2404 may be configured to cause output device 2430 of client computing device 2450 to output condensed patient summary 2432. Condensed patient summary 2432 may be generated, e.g., as output on a display screen, so as to allow a physician or other medical professional to easily see what procedures a patient has had conducted and what medications they have been given, whether it be by the same medical professional or a different medical professional. A condensed patient summary may comprise at least one of a date of visit, a physician name, a diagnoses list, a medication list, a procedure performed, a test, a test result, a vaccination, a diagnostic study, a body scan, coded medical data, or translations of coded medical data.

Similar to the standalone example of FIG. 23, in the distributed example of FIG. 24, in one example, memory 2414 stores medical records 2418 and administrative medical data 2420. These could be stored in databases, data warehouses, in a cloud data structure, or on a hard disk, among other things. Medical records 2418 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 2420 could contain codes pertaining to charge data and costs that will be billed to a payer, such as the government or an insurance company, although the techniques of this disclosure may apply to other payers.

NLP module 2404 is configured to associate different codes in administrative medical data 2420 to specific natural language meanings. NLP module 2404 translates the information contained in administrative medical data 2420 into those natural language meanings to describe what a patient was charged for during their encounter in the medical facility. NLP module 2404 then analyzes that information along with the medical records 2418, which should also give a natural language description of what a patient was administered during their encounter in the medical facility.

NLP module 2404 analyzes the information contained in medical records 2418 and the information contained in administrative medical data 2420. NLP module 2404 may, in some examples, analyze the information contained in medical records 2418 and the information contained in administrative medical data 2420 by strictly comparing the two. In other examples, NLP module 2404 may use a natural language processing model to parse out particular keywords and synonyms for those keywords in the information contained in medical records 2418 and the information contained in administrative medical data 2420. NLP module 2404 may then compare those keywords and synonyms to reduce the number of false negatives incurred by the system by accounting for different terminologies used between different physicians and medical professionals or between a medical professional and the codes of administrative medical data 2420.

NLP module 2404 assembles a condensed patient summary 2432 based on the analysis of the information contained in medical records 2418 and information contained in coded administrative data 2420. The condensed patient summary 2432 contains information about all of the procedures done on a patient so that medical professionals can better coordinate care rather than risk the possibility of administering a medication or a test multiple times.

NLP module 2404 outputs, at output device 2430 of client computing device 2450, the condensed patient summary 2432. In some examples, medical records 2418 may be entered by more than one different physician or medical specialist, allowing the care to be coordinated and for condensed patient summary 2432 to contain a collaboration of material.

Communication interfaces 2426 and 2452 allow for communication between server computing device 2410 and client computing device 2450 via network 2440. In this way, NLP module 2404 may execute on server computing device 2410 but the output may appear on output device 2430 of client computing device 2450. A user operating on client computing device 2450 may log-on or otherwise access NLP module 2404 of server computing device 2410, such as via a web-interface operating on the Internet or a propriety network, or via a direct or dial-up connection between client computing device 2450 and server computing device 2410. In some cases, data displayed on output device 2430 may be arranged in web pages served from server computing device 2410 to client computing device 2450 via hypertext transfer protocol (HTTP), extended markup language (XML), or the like.

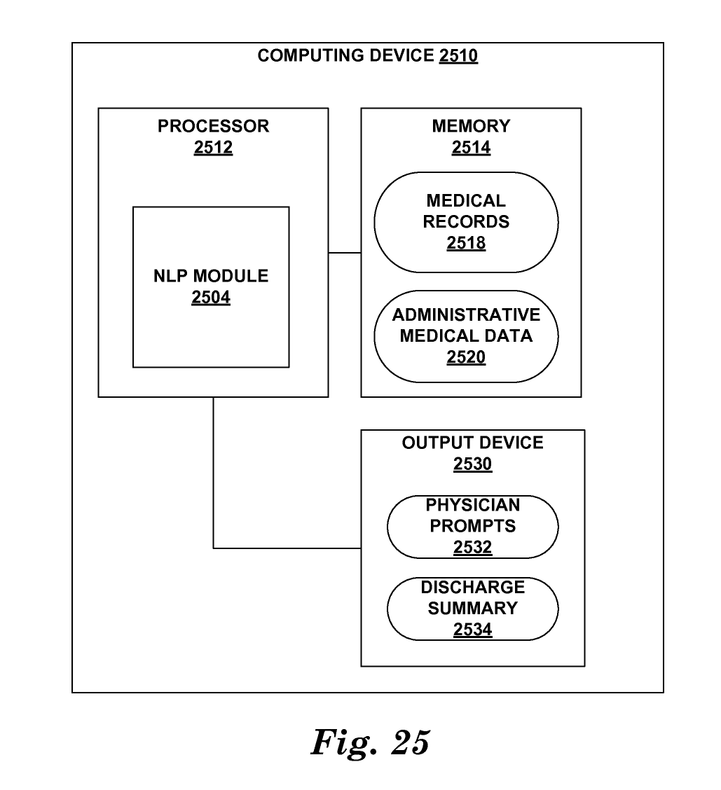

FIG. 25 is a block diagram illustrating an example of a standalone computing device for creating a discharge summary, in accordance with one or more techniques of the current disclosure. Discharge summaries are now required to be created within 36 hours of discharge and must be available online, per governmental regulations. Documents will be searched utilizing NLP to search structured and unstructured text to capture concepts from regions/sections of documents to create a draft discharge summary from the encounter/admission, along with medication list, discharge instructions, diagnostic studies, consultations and procedures performed during the visit. This will be surfaced to the physician in draft format any time after documents are created and electronically submitted. The physician would then edit, finalize and sign the final discharge summary. The system comprises computing device 2510 that includes a processor 2512, a memory 2514, and an output device 2530. Computing device 2510 may also include many other components. The illustrated components are shown merely to explain various aspects of this disclosure. Computing device 2510 may be a desktop computer, a tablet computer, a personal digital assistant (PDA), a laptop computer, a portable media player, an e-book reader, a watch, a television platform, or another type of computing device.

The output device 2530 may comprise a display screen, although this disclosure is not necessarily limited in this respect, and other types of output devices may also be used. Memory 2514 stores medical records 2518, comprising textual and numeric information for a plurality of medical records, and administrative medical data 2520, comprising coded medical procedures and charge data for said medical procedures. Processor 2512 is configured to include an NLP module 2504 which executes techniques of this disclosure with respect to medical records 2518 and administrative medical data 2520.

Processor 2512 may comprise a general-purpose microprocessor, a specially designed processor, an application specific integrated circuit, a field programmable gate array, a collection of discrete logic, or any type of processing device capable of executing the techniques described herein. In one example, memory 2514 may store program instructions (e.g., software instructions) that are executed by processor 2512 to carry out the techniques described herein. In other examples, the techniques may be executed by specifically programmed circuitry of processor 2512. In these or other ways, processor 2512 may be configured to execute the techniques described herein.

Output device 2530 may comprise a display screen, and may also include other types of output capabilities. In some cases, output device 2530 may generally represent both a display screen and a printer in some cases. NLP module 2504 may be configured to cause output device 2530 to output physician prompts 2532 and discharge summary 2534. Physician prompts 2532 may be generated, e.g., as output on a display screen, so as to allow a physician or other medical professional to add or modify portions of discharge summary 2534. Discharge summary 2534 may be generated, e.g., as output on a display screen, to summarize the patient's encounter, including procedures, diagnoses, and treatment schedules.

In one example, memory 2514 stores medical records 2518 and administrative medical data 2520. These could be stored in databases, data warehouses, in cloud data structures, or on a hard disk, among other things. Medical records 2518 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 2520 could contain codes pertaining to charge data and costs that will be billed to a payer, such as the government or an insurance company, although the techniques of this disclosure may apply to other payers.

NLP module 2504 is configured to associate different codes in administrative medical data 2520 to specific natural language meanings. NLP module 2504 translates the information contained in administrative medical data 2520 into those natural language meanings to describe what a patient was charged for during their encounter in the medical facility. NLP module 2504 then analyzes that information along with medical records 2518, which should also give a natural language description of what a patient was administered during their encounter in the medical facility.

NLP module 2504 analyzes the information contained in medical records 2518 and the information contained in administrative medical data 2520. NLP module 2504 may, in some examples, analyze the information contained in medical records 2518 and the information contained in administrative medical data 2520 by strictly comparing the two. In other examples, NLP module 2504 may use a natural language processing model to parse out particular keywords and synonyms for those keywords in the information contained in medical records 2518 and the information contained in administrative medical data 2520. NLP module 2504 may then compare those keywords and synonyms to reduce the number of false negatives incurred by the system by accounting for different terminologies used between different physicians and medical professionals or between a medical professional and the codes of administrative medical data 2520.

NLP module 2504 sorts the information contained in medical records 2518 and information contained in coded administrative data 2520 into a plurality of discharge components. An organized listing of discharge summary components form discharge summary 2534, and comprise at least a portion of an encounter summary, a medication list, a listing of discharge instructions, a diagnostic study, a consultation summary, and a procedure summary.

NLP module 2504 outputs information in the form of physician prompts 2532 and discharge summary 2534. In some examples, medical records 2518 are stored periodically throughout a patient's visit, and NLP module 2504 further updates the discharge summary each time a new medical record is stored. In some examples, this process is executed within a period of time after a patient is discharged as mandated by the government. In some examples, the period of time mandated by the government is 36 hours. In some examples, NLP module 2504 further uploads the discharge summary 2534 to the internet. In some examples, NLP module 2504 further prompts a physician to edit, finalize, and sign discharge summary 2534 through the use of physician prompts 2532.

In one embodiment, the disclosure is directed to a method for analyzing medical documentation. One or more computing devices store a plurality of medical records and coded administrative data. The one or more computing devices analyze information contained in the plurality of medical records and information contained in the coded administrative data. The one or more computing devices sorts the information contained in the plurality of medical records and the information contained in the coded administrative data into a plurality of discharge summary components. The one or more computing devices output the discharge summary.

The system of FIG. 25 is a standalone system in which processor 2512 that executed NLP module 2504 and output device 2530 that outputs physician prompts 2532 and discharge summary 2534 reside on the same computing device 2510. However, the techniques of this disclosure may also be performed in a distributed system that includes a server computing device and a client computing device. In this case, the client computing device may communicate with the server computing device via a network. The NLP module 2504 may reside on the server computing device, but the output device may reside on the client computing device. In this case, when the NLP module 2504 causes display prompts, the NLP module 2504 causes the output device of the client computing device to display the prompts, e.g., via commands or instructions communicated from the server computing device to the client computing device. The NLP module 2504 may simply avoid such commands or instructions if display of the prompts at the output device is avoided.

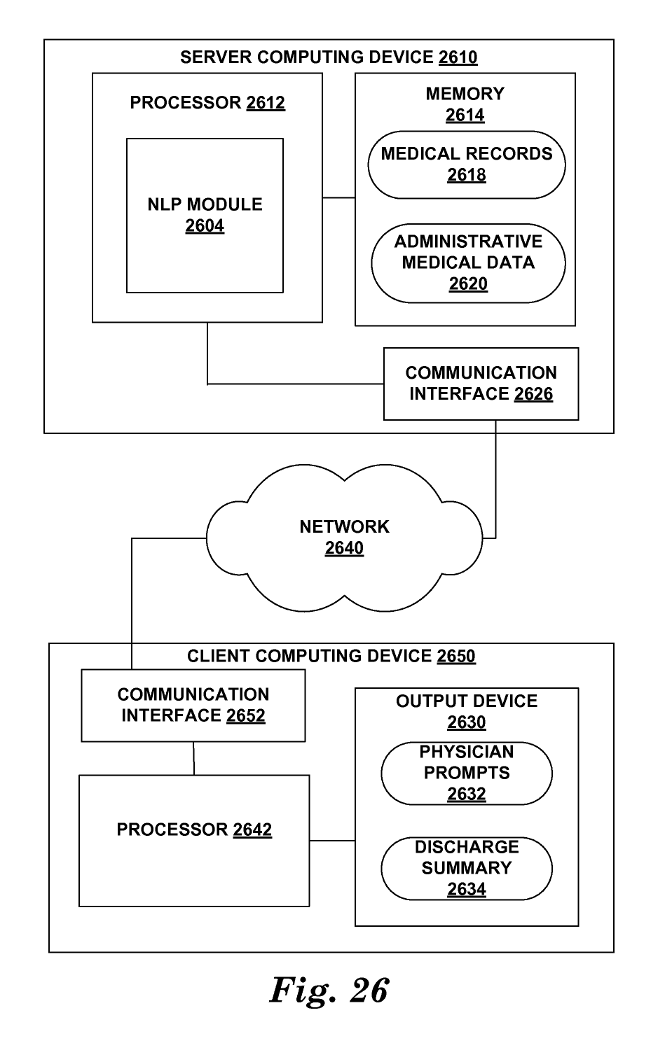

FIG. 26 is a block diagram illustrating an example of a distributed system for creating a discharge summary, in accordance with one or more techniques of the current disclosure. This system includes a server computing device 2610 and a client computing device 2650 that communicate via a network 2640. In the example of FIG. 26, network 2640 may comprise a proprietary on non-proprietary network for packet-based communication. In one example, network 2640 comprises the Internet, in which case communication interfaces 2626 and 2652 may comprise interfaces for communicating data according to transmission control protocoVinternet protocol (TCP/IP), user datagram protocol (UDP), or the like. More generally, however, network 2640 may comprise any type of communication network, and may support wired communication, wireless communication, fiber optic communication, satellite communication, or any type of techniques for transferring data between a source (e.g., server computing device 2610) and a destination (e.g., client computing device 2640).

Server computing device 2610 may perform the techniques of this disclosure, but a user may interact with the system via client computing device 2650. Server computing device 2610 may be implemented in a Cloud based environment. Server computing device 2610 may include a processor 2612, a memory 2614, and a communication interface 2626. Client computing device 2650 may include a communication interface 2652, a processor 2642 and an output device 2630. Of course, client computing device 2650 and server computing device 2610 may include many other components. The illustrated components are shown merely to explain various aspects of this disclosure.

Output device 2630 may comprise a display screen, although this disclosure is not necessarily limited in this respect and other output devices may also be used. Memory 2614 stores medical records 2618 comprising a plurality of medical records, as well as administrative medical data 2620, comprising coded medical procedures and charge data for said medical procedures. Processor 2612 of server computing device 2610 is configured to include a NLP module 2604 which executes techniques of this disclosure with respect to medical records 2618 and administrative medical data 2620.

Processors 2612 and 2642 may each comprise a general-purpose microprocessor, a specially designed processor, an application specific integrated circuit, a field programmable gate array, a collection of discrete logic, or any type of processing device capable of executing the techniques described herein. In one example, memory 2614 may store program instructions (e.g., software instructions) that are executed by processor 2612 to carry out the techniques described herein. In other examples, the techniques may be executed by specifically programmed circuitry of processor 2612. In these or other ways, processor 2612 may be configured to execute the techniques described herein.

Output device 2630 on client computing device 2650 may comprise a display screen, and may also include other types of output capabilities. In some cases, output device 2630 may generally represent both a display screen and a printer in some cases. NLP module 2604 may be configured to cause output device 2630 of client computing device 2650 to output physician prompts 2632 and discharge summary 2634. Physician prompts 2632 may be generated, e.g., as output on a display screen, so as to allow a physician or other medical professional to add or modify portions of discharge summary 2634. Discharge summary 2634 may be generated, e.g., as output on a display screen, to summarize the patient's encounter, including procedures, diagnoses, and treatment schedules.

Similar to the standalone example of FIG. 25, in the distributed example of FIG. 26, in one example, memory 2614 stores medical records 2618 and administrative medical data 2620. These could be stored in databases, data warehouses, in a cloud data structure, or on a hard disk, among other things. Medical records 2618 could contain natural language describing the events that occurred during a patient's encounter in a medical facility, such as a doctor's office or a hospital. These events could include diagnoses, tests, test results, surgeries, procedures, prescriptions, medications used while admitted, or anything else dealing with the care received during the encounter. Administrative medical data 2620 could contain codes pertaining to charge data and costs that will be billed to a payer, such as the government or an insurance company, although the techniques of this disclosure may apply to other payers.

NLP module 2604 is configured to associate different codes in administrative medical data 2620 to specific natural language meanings. NLP module 2604 translates the information contained in administrative medical data 2620 into those natural language meanings to describe what a patient was charged for during their encounter in the medical facility. NLP module 2604 then analyzes that information along with medical records 2618, which should also give a natural language description of what a patient was administered during their encounter in the medical facility.

NLP module 2604 analyzes the information contained in medical records 2618 and the information contained in administrative medical data 2620. NLP module 2604 may, in some examples, analyze the information contained in medical records 2618 and the information contained in administrative medical data 2620 by strictly comparing the two. In other examples, NLP module 2604 may use a natural language processing model to parse out particular keywords and synonyms for those keywords in the information contained in medical records 2618 and the information contained in administrative medical data 2620. NLP module 2604 may then compare those keywords and synonyms to reduce the number of false negatives incurred by the system by accounting for different terminologies used between different physicians and medical professionals or between a medical professional and the codes of administrative medical data 2620.

NLP module 2604 sorts the information contained in medical records 2618 and information contained in coded administrative data 2620 into a plurality of discharge components. An organized listing of discharge summary components form discharge summary 2634, and comprise at least a portion of an encounter summary, a medication list, a listing of discharge instructions, a diagnostic study, a consultation summary, and a procedure summary.

NLP module 2604 outputs, at output device 2630 of client computing device 2650, information in the form of physician prompts 2632 and discharge summary 2634. In some examples, medical records are stored periodically throughout a patient's visit, and NLP module 2604 further updates the discharge summary each time a new medical record is stored. In some examples, this process is executed within a period of time after a patient is discharged as mandated by the government. In some examples, the period of time mandated by the government is 36 hours. In some examples, NLP module 2604 further uploads the discharge summary 2634 to the internet. In some examples, NLP module 2604 further prompts a physician to edit, finalize, and sign discharge summary 2634 through the use of physician prompts 2632.

Communication interfaces 2626 and 2652 allow for communication between server computing device 2610 and client computing device 2650 via network 2640. In this way, NLP module 2604 may execute on server computing device 2610 but the output may appear on output device 2630 of client computing device 2650. A user operating on client computing device 2650 may log-on or otherwise access NLP module 2604 of server computing device 2610, such as via a web-interface operating on the Internet or a propriety network, or via a direct or dial-up connection between client computing device 2650 and server computing device 2610. In some cases, data displayed on output device 2630 may be arranged in web pages served from server computing device 2610 to client computing device 2650 via hypertext transfer protocol (HTTP), extended markup language (XML), or the like.

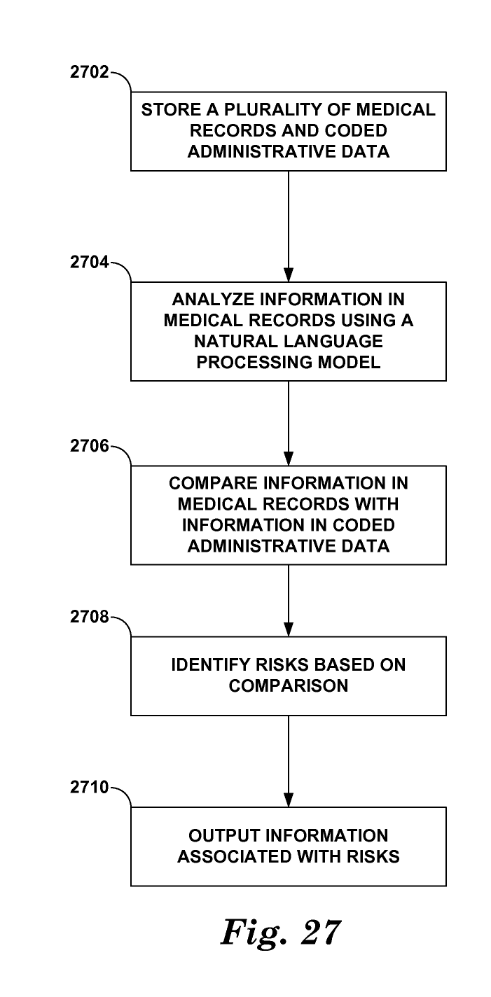

FIG. 27 is a flow diagram illustrating a method for auditing medical records, in accordance with one or more techniques of the current disclosure. One or more computing devices store a plurality of medical records and coded administrative data (2702). The one or more computing device analyze the information in the medical records using a natural language processing model (2704). The one or more computing devices compare information contained in the plurality of medical records with information contained in coded administrative data (2706). The one or more computing devices identify one or more risks based on the comparison of the information contained in the plurality of medical records with the information contained in the coded administrative data (2708). The one or more computing devices output information associated with the one or more risks in the medical documentation (2710).

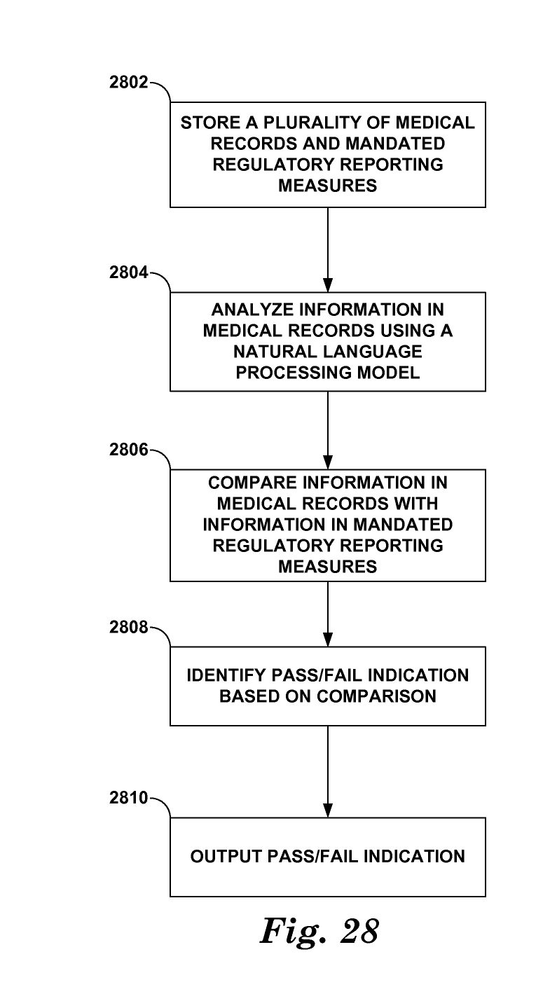

FIG. 28 is a flow diagram illustrating a method for quality control, in accordance with one or more techniques of the current disclosure. One or more computing devices store a plurality of medical records and mandated regulatory reporting measures (2802). The one or more computing device analyze the information in the medical records using a natural language processing model (2804). The one or more computing devices compare information contained in the plurality of medical records with information contained in mandated regulatory reporting measures (2806) for a given procedure or diagnosis. The one or more computing devices identify a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for a given procedure or diagnosis (2808). The one or more computing devices output the pass/fail indication (2810).

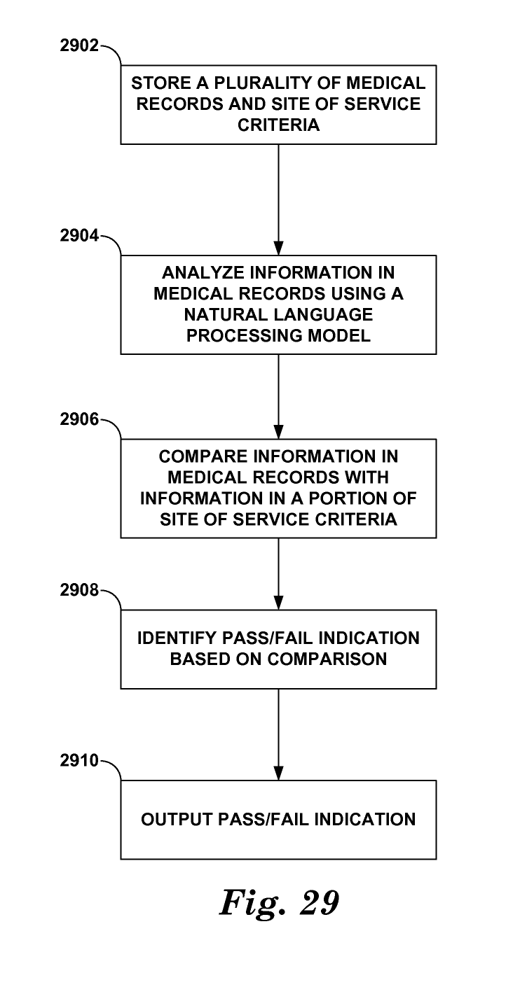

FIG. 29 is a flow diagram illustrating a method for assessing site of service qualifications, in accordance with one or more techniques of the current disclosure. One or more computing devices store a plurality of medical records and site of service criteria (2902). The one or more computing device analyze the information in the medical records using a natural language processing model (2904). The one or more computing devices compare information contained in the plurality of medical records with a portion of information contained in the site of service criteria required for a site of service status in the plurality of medical records (2906). The one or more computing devices identify a pass/fail indication based on the comparison of the information contained in the plurality of medical records with the portion of information contained in the site of service criteria based on whether the information contained in the plurality of medical records includes the portion of information contained in the set of site of service criteria (2908). The one or more computing devices output the pass/fail indication (2910).

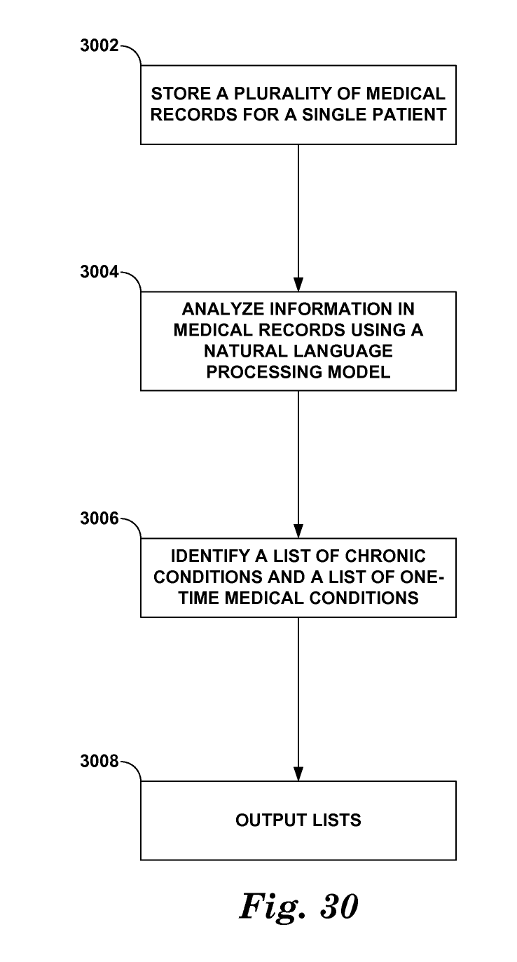

FIG. 30 is a flow diagram illustrating a method for identifying chronic patient conditions, in accordance with one or more techniques of the current disclosure. One or more computing devices store a plurality of medical records for a single patient (3002). The one or more computing device analyze the information in the medical records using a natural language processing model (3004). The one or more computing devices identify a list of chronic conditions for the patient and a list of one-time medical conditions for the patient based on a number of instances the patient has sought medical attention for the given conditions (3006). The one or more computing devices output the list of chronic conditions for the patient and the list of one-time medical conditions for the patient (3008).

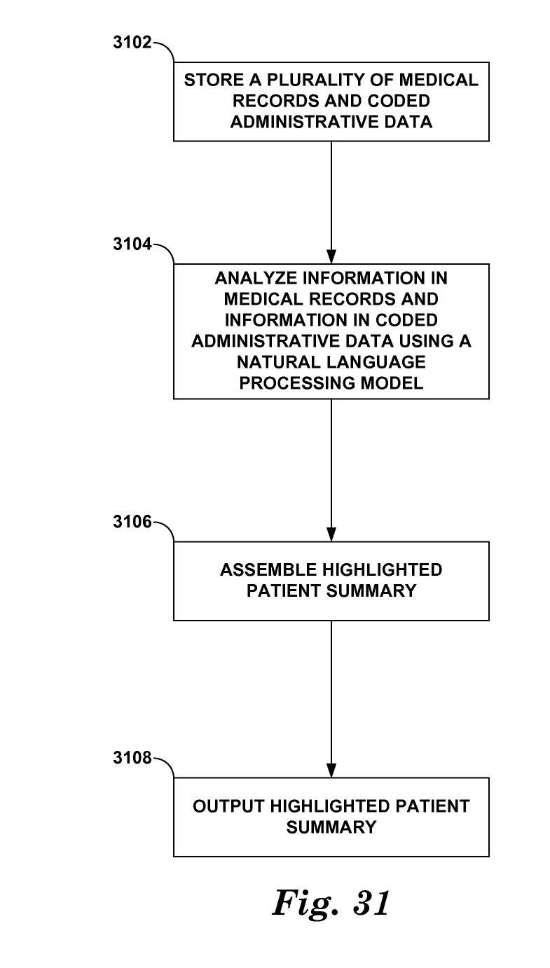

FIG. 31 is a flow diagram illustrating a method for coordination of care, in accordance with one or more techniques of the current disclosure. One or more computing devices store a plurality of medical records and coded administrative data (3102). The one or more computing device analyze the information in the medical records and the information in the coded administrative data using a natural language processing model (3104). The one or more computing devices assemble a condensed patient summary based on the information contained in the plurality of medical records and the information contained in the coded administrative data (3106). The one or more computing devices output the condensed patient summary (3108).

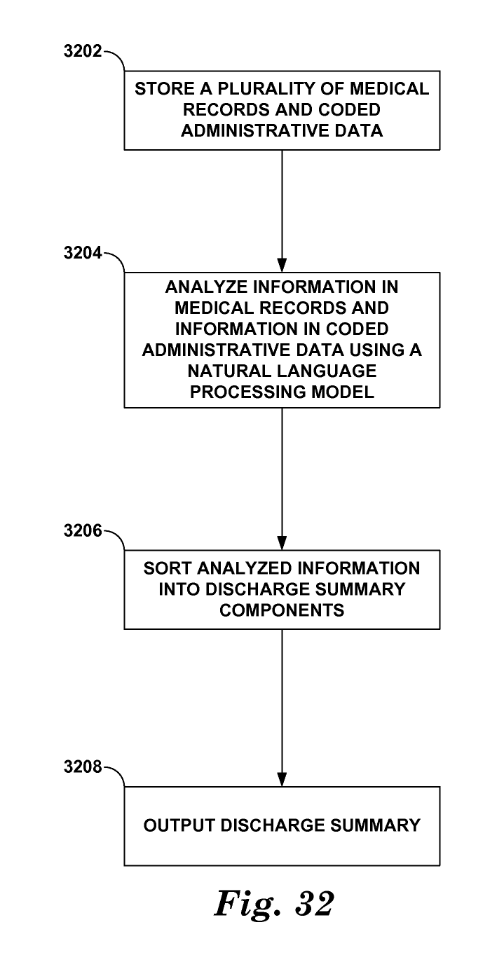

FIG. 32 is a flow diagram illustrating a method for creating a discharge summary, in accordance with one or more techniques of the current disclosure. One or more computing devices store a plurality of medical records and coded administrative data (3202). The one or more computing device analyze the information in the medical records and the information in the coded administrative data using a natural language processing model (3204). The one or more computing devices sort the information contained in the plurality of medical records and the information contained in the coded administrative data into a plurality of discharge summary components (3206). The one or more computing devices output the discharge summary (3208).

The techniques of this disclosure may be implemented in a wide variety of computer devices, such as servers, laptop computers, desktop computers, notebook computers, tablet computers, hand-held computers, smart phones, and the like. Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

Various embodiments of the invention have been described. These and other embodiments are within the scope of the following claims.

1. A method for analyzing medical documentation, the method comprising:
storing, by one or more computing devices, a plurality of medical records and mandated regulatory reporting measures;
comparing, by the one or more computing devices, information contained in the plurality of medical records with information contained in the mandated regulatory reporting measures for a given procedure or diagnosis;
identifying, by the one or more computing devices, a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis; and
outputting, by the one or more computing devices, the pass/fail indication.

2. The method of claim 1, further comprising analyzing, by the one or more computing devices, the information contained in the plurality of medical records using a natural language processing model.

3. The method of claim 1, further comprising sending, by the one or more computer devices, the information contained in the plurality of medical records and the pass/fail indication to an outside reporting agency.

4. The method of claim 1, further comprising, upon outputting a fail indication, prompting, by the one or more computing devices, for an explanation of the fail indication or a remedy of the fail indication.

5-6. (canceled)

7. A computerized system for analyzing medical documentation, the system comprising a computer that includes a processor and a memory, wherein the processor is configured to include a natural language processing module, wherein:
the natural language processing module stores a plurality of medical records and mandated regulatory reporting measures;
the natural language processing module compares information contained in the plurality of medical records with information contained in the mandated regulatory reporting measures for a given procedure or diagnosis;
the natural language processing module identifies a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis; and
the natural language processing module outputs the pass/fail indication.

8. The system of claim 7, wherein the natural language processing module further analyzes the information contained in the plurality of medical records using a natural language processing model.

9. The system of claim 7, wherein the natural language processing module further sends the information contained in the plurality of medical records and the pass/fail indication to an outside reporting agency.

10. The system of claim 7, wherein the natural language processing module further, upon outputting a fail indication, prompts for an explanation of the fail indication or a remedy of the fail indication.

11. The system of claim 7, wherein the entire system is located in a standalone computing device.

12. The system of claim 7, wherein the natural language processing module is located in a server computing device that communicates with a client computing device via a network, wherein the output is shown at the client computing device.

13. A computer-readable storage medium comprising instructions that when executed in a processor cause the processor to analyze medical documentation, wherein upon execution the instructions cause the processor to:
store a plurality of medical records and mandated regulatory reporting measures;
compare information contained in the plurality of medical records with information contained in the mandated regulatory reporting measures for a given procedure or diagnosis;
identify a pass/fail indication based on the comparison of the information contained in the plurality of medical records with the information contained in the mandated regulatory reporting measures based on whether the information contained in the plurality of medical records includes expected care to be given as required by the information contained in the mandatory regulatory reporting measures for the given procedure or diagnosis; and
output the pass/fail indication.

14. The computer-readable storage medium of claim 13, wherein the instructions further cause the processor to analyze the information contained in the plurality of medical records using a natural language processing model.

15. The computer-readable storage medium of claim 13, wherein the instructions further cause the processor to send the information in the plurality of medical records and the pass/fail indication to an outside reporting agency.

16. The computer-readable storage medium of claim 13, wherein the instructions further cause the processor to, upon outputting a fail indication, prompt for an explanation of the fail indication or a remedy of the fail indication.

17-114. (canceled)

115. The method of claim 1, wherein the pass/fail indication comprises a first pass/fail indication, and wherein the method further comprises:
storing, by the one or more computing devices, site of service criteria;
comparing, by the one or more computing devices, the information contained in the plurality of medical records with a portion of information contained in the site of service criteria required for a site of service status in the plurality of medical records;
identifying, by the one or more computing devices, a second pass/fail indication based on the comparison of the information contained in the plurality of medical records with the portion of information contained in the site of service criteria based on whether the information contained in the plurality of medical records includes the portion of information contained in the set of site of service criteria; and
outputting, by the one or more computing devices, the second pass/fail indication.

116. The method of claim 5, further comprising:
upon outputting the second pass/fail indication as a fail indication, prompting, by the one or more computing devices, for an explanation of the incorrect site of service status or a remedy of the fail indication.

117. The method of claim 5, wherein the site of service criteria describes one of:
a level of care to be given to a patient, or
a specific ward for a patient to be placed in.

118. The system of claim 7, wherein the pass/fail indication comprises a first pass/fail indication, and wherein the natural language processing module further:
stores site of service criteria;
compares the information contained in the plurality of medical records with a portion of information contained in the site of service criteria required for a site of service status in the plurality of medical records;
identifies a second pass/fail indication based on the comparison of the information contained in the plurality of medical records with the portion of information contained in the site of service criteria based on whether the information contained in the plurality of medical records includes the portion of information contained in the set of site of service criteria; and
outputs the second pass/fail indication.

119. The system of claim 118, wherein the natural language processing module further:
upon outputting the second pass/fail indication as a fail indication, prompts for an explanation of the incorrect site of service status or a remedy of the fail indication.

120. The system of claim 118, wherein the site of service criteria describes one of:
a level of care to be given to a patient, or
a specific ward for a patient to be placed in.
